(19) United States
(12) Patent Application Publication
(10) Pub. No.: US 2022/0403188 A1
(43) Pub. Date: Dec. 22, 2022

(54) INKJET INK

(71) Applicant: HEWLETT-PACKARD DEVELOPMENT COMPANY, L.P., Spring, TX (US)

(72) Inventors: Zhang-Lin Zhou, San Diego, CA (US); Qianhan Yang, San Diego, CA (US)

(21) Appl. No.: 17/341,004

(22) Filed: Jun. 7, 2021

(51) Int. Cl. C09D 11/102; C09D 11/324; C08L 75/04; C08G 18/75; C08G 18/44; C08G 18/62; C08F 220/14; C08F 220/18; C08F 220/28; C08G 18/08; C08G 18/12; C08G 18/32; B41J 11/00; C09D 11/54

(52) U.S. Cl. CPC C09D 11/102; C09D 11/324; C08L 75/04; C08G 18/755; C08G 18/44; C08G 18/6229; C08F 220/14; C08F 220/1808; C08F 220/286; C08G 18/0828; C08G 18/12; C08G 18/3206; C08G 18/3228; B41J 11/002; C09D 11/54; C08L 2205/14; C08L 2205/025

(57) ABSTRACT

An inkjet ink includes a polyurethane binder particle including at least two polyurethane polymers; a pigment; and an aqueous vehicle. A first of the at least two polyurethane polymers has a first backbone chain formed from a first diisocyanate, a first hydrophobic graft diol, a first polycarbonate based diol, and a sulfonated diamine. A second of the at least two polyurethane polymer has a second backbone chain formed from a second diisocyanate, a second hydrophobic graft diol, and a second polycarbonate based diol, and includes a mono-amino substituted sulfonic acid as its capping moiety.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces, for many reasons, including, low printer noise, capability of high-speed recording and multi-color recording. In some instances, an ink set (which may include two or more different colored inks) may be used as an ink source for the inkjet printing system. The ink droplets are ejected from a nozzle by the inkjet system onto the medium to produce an image thereon. The inks play a fundamental role in the image quality resulting from this printing technique.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a schematic illustration of a portion of one polyurethane polymer of the polyurethane binder particles disclosed herein;

FIG. 1B is a schematic illustration of a portion of another polyurethane polymer of the polyurethane binder particles disclosed herein;

FIG. 2 is a flow diagram illustrating an example of a method for making an example of an inkjet ink that includes the polyurethane binder particles described herein;

FIG. 3 is a flow diagram illustrating an example of a method for printing a printed image;

FIG. 4 is a graph of the optical density performance of examples of the inkjet ink described herein when printed on various substrates;

FIGS. 5A-5C are graphs depicting the results from several durability tests performed using example prints and a comparative example print formed on various substrates;

FIG. 6 is a graph of the stability performance (in terms of particle size as a volume-weighted mean diameter (PS MV)) of examples of the inkjet ink disclosed herein and a comparative example inkjet ink before and after being exposed to different stability tests;

FIGS. 7A and 7B each include two graphs depicting the results of jettability performance tests of examples of the inkjet ink described herein and the comparative example inkjet ink; and

FIG. 8 is a graph of the turn-on-energy (TOE) curves of examples of the inkjet ink described herein and the comparative example inkjet ink.

### DETAILED DESCRIPTION

In inkjet printing, the ink composition can affect both the printability of the ink and the print attributes of images that are formed with the ink. As such, ink performance, in terms of both printability and printed image attributes, may be controlled by modifying the components of the ink composition. However, adjusting an ink composition to achieve one attribute of ink performance may result in the compromise of another attribute. For example, increasing a binder amount in an ink can improve the durability of a printed image; however, an increase in binder can also deleteriously affect the printability of the ink by increasing the viscosity, which can lead to clogged nozzles in the printhead, etc.

A single ink composition may also exhibit different print performance attributes on different types of media, due in part, to the different components within the different types of media. Print performance attributes that may vary from one media type to another may include optical density of the printed image, rub resistance of the printed image, and durability (e.g., scratch resistance) of the printed image. An ink composition may form very different prints when printed, for example, on plain paper and coated paper.

Disclosed herein is an inkjet ink that is particularly suitable for obtaining printed images, on a variety of different media, which have desirable opacity, durability, stability, and/or jettability. Examples of the inkjet ink include polyurethane polymer particles, which have been found to increase the durability of the print images on plain paper and coated paper media while maintaining jettability.

The polyurethane polymer particles include at least two polyurethane polymers, one of which includes sulfonate groups along the backbone chain (introduced via a sulfonated diamine chain extender) and the other of which includes a sulfonate group as a capping moiety (introduced via a mono-amino substituted sulfonic acid). The polyurethane polymer with sulfonate groups along the backbone chain helps to improve print quality, such as optical density. The polyurethane polymer with sulfonate groups as the capping moiety helps to control the particle size (which can affect jettability and/or printed image durability), as the mono-amino substituted sulfonic acid terminates its polymerization. If used alone, however, this type of polyurethane polymer may have reduced print quality, due to a reduced number of sulfonate groups. Thus, the polyurethane polymer particles disclosed herein provide a balance of suitable print quality as well as jettability and print durability.

The polyurethane polymer particles disclosed herein are sulfonated, and not carboxylated. The addition of carboxylate groups can have adverse effects on the quality of the printed image. As set forth herein, the polyurethane polymer particles include sulfonate groups, without carboxylate groups. As such, the example inkjet inks exhibit good image quality (e.g., optical density) and durability while maintaining jettability parameters.

Each of the polyurethane polymers in the polyurethane polymer particles is also prepared with a hydrophobic graft diol. The hydrophobic group may be contributing to the ink performance, such as durability and jettability, on a variety of different media.

Throughout this disclosure, a weight percentage that is referred to as “wt % active” refers to the loading of an active component of a dispersion or other formulation that is present in the inkjet ink. For example, the pigment may be present in a water-based formulation (e.g., a stock solution or dispersion) before being incorporated into the inkjet ink. In this example, the wt % actives of the pigment accounts for the loading (as a weight percent) of the pigment that is present in the inkjet ink, and does not account for the weight of the other components (e.g., water, etc.) that are present in the formulation with the pigment.

The term “molecular weight” as used herein refers to weight average molecular weight (Mw), the units of which are g/mol or Daltons.

Also used herein, the term “average particle size” refers to a volume-weighted mean diameter of a particle size distribution.

Inkjet Ink

The inkjet ink disclosed herein includes a polyurethane binder particle including at least two polyurethane polymers, wherein: a first of the at least two polyurethane polymers has a first backbone chain formed from a first diisocyanate, a first hydrophobic graft diol, a first polycarbonate based diol, and a sulfonated diamine; and a second of the at least two polyurethane polymer has a second backbone chain formed from a second diisocyanate, a second hydrophobic graft diol, and a second polycarbonate based diol, and includes a mono-amino substituted sulfonic acid as its capping moiety; a pigment; and an aqueous vehicle. In some instances, the inkjet ink consists of these components. In other instances, the inkjet ink may include other additives or components.

The inkjet ink includes the polyurethane binder particles. The polyurethane binder particles include at least two polyurethane polymers. The first of the polyurethane polymers in the particles has a first backbone chain formed from a first diisocyanate, a first hydrophobic graft diol, a first polycarbonate based diol, and a sulfonated diamine. The second of the polyurethane polymers in the particles has a second backbone chain formed from a second diisocyanate, a second hydrophobic graft diol, and a second polycarbonate based diol, and includes a mono-amino substituted sulfonic acid as its capping moiety. The second polyurethane polymers tend to have a lower molecular weight than the first polyurethane polymers, and may be intermingled among the first polyurethane polymers in the binder particles.

As used herein, the phrase “formed from” means that the listed components are used in a polymerization reaction to generate the polyurethane polymer(s). As such, the terms “polymerized isocyanates,” “polymerized polymeric diols,” “polymerized hydrophobic graft diols,” and “polymerized sulfonated diamines” refer to the respective monomers in their polymerized states (e.g., after the monomers have bonded together to form a polyurethane chain). It is to be understood that the monomers change in certain ways during polymerizing, and do not exist as separate molecules in the polymer.

The terms “first” and “second” when used to describe the polyurethane polymer and its components are not meant to imply different chemical species, orientation or order, but rather are used to distinguish the polyurethane backbone chains and their respective chemical makeup. For example, when synthesizing the polyurethane binder particles, the reaction mixture may include one type of diisocyanate, one type of hydrophobic graft diol, and one type of polycarbonate based diol. The term “type” refers to a particular chemical structure. In an example, the first and second diisocyanates of the same type are isophorone diisocyanate. During the reaction, the diisocyanate, the hydrophobic graft diol, and the polycarbonate based diol react to form a plurality of pre-polymer chains, and then some of these pre-polymer chains will further react with the mono-amino substituted sulfonic acid to form the “second” polyurethane polymer, and others of these pre-polymer chains will further react with the sulfonated diamine to form the “first” polyurethane polymer. Each of the first and second polyurethane polymers includes different molecules of the same type of diisocyanate, different molecules of the same type of hydrophobic graft diol, and different molecules of the same type of polycarbonate based diol. As such, in the examples disclosed herein the first and second diisocyanates are the same type of diisocyanate, the first and second hydrophobic graft diols are the same type of hydrophibic graft diol, and the first and second polycarbonate based diol are the same type of polycarbonate based diol.

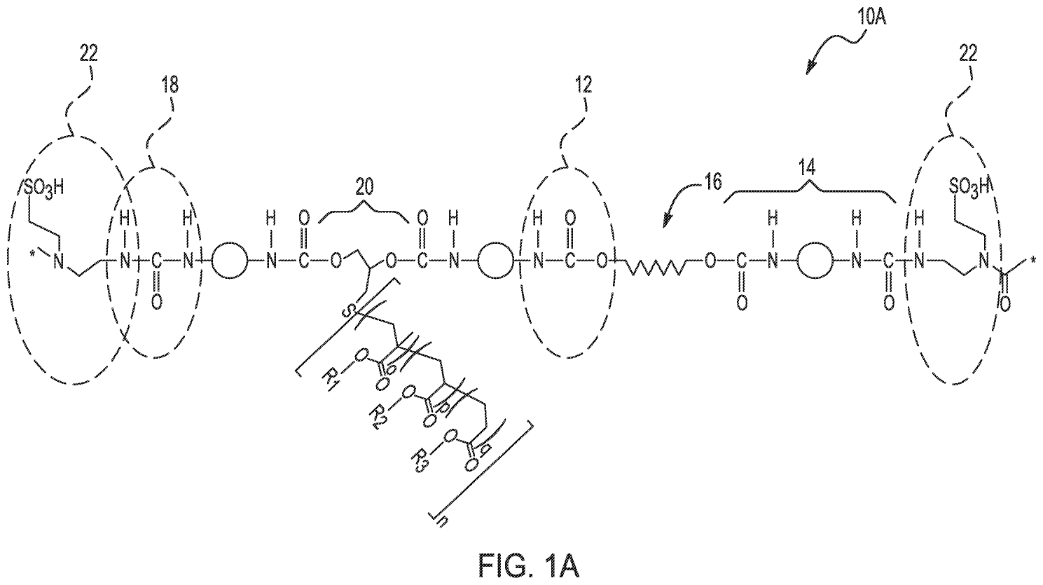

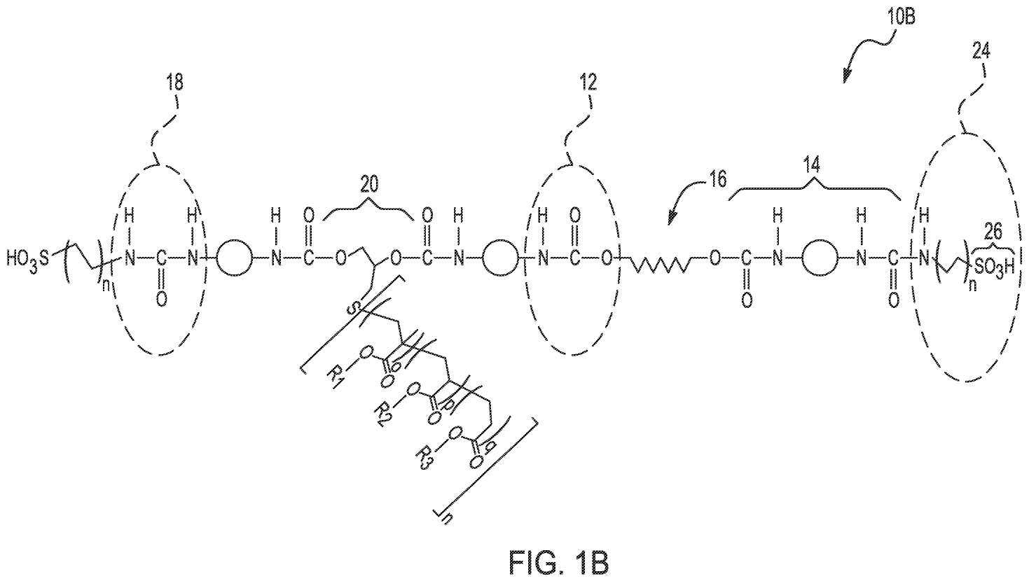

FIG. 1A depicts a portion of the first polyurethane polymer 10A that is present as part of the polyurethane binder particles described herein. FIG. 1 does not show the cross-linking that may occur with the first polyurethane polymer 10A, but rather shows the types of groups of moieties that can be present along the first polyurethane polymer 10A, some of which are available for internal crosslinking.

The first polyurethane polymer structure 10A in FIG. 1A includes several chemical moieties, such as urethane linkage groups 12 (formed by the reaction of isocyanate groups 14 with any of a number of polycarbonate based diols 16 that may be present). A carbon atom of an isocyanate group 14 reacts with an oxygen atom of a hydroxyl of the polycarbonate based diol 16 to form the urethane linkage group 12. The polycarbonate based diols 16 and the isocyanate groups 14 are shown schematically after polymerization. The isocyanate groups 14 are shown along the polyurethane backbone, and are schematically represented by a circle with isocyanate groups on either side thereof. Other chemical moieties represented in FIG. 1A include a urea group 18 (formed by the reaction of isocyanate groups 14 with any of a number of sulfonated diamines 22 that may be present), and a sulfonated diamine 22. The amines of the sulfonated diamine 22 are present along the polymer backbone, and the sulfonate group of the sulfonated diamine 22 is included in a side chain (e.g. —(CH₂₎ₓSO₃H) off the polymer backbone. Still other chemical moieties represented in FIG. 1A include a hydrophobic graft diol 20. A carbon atom of an isocyanate group 14 reacts with an oxygen atom of a hydroxyl of the hydrophobic graft diol 20 to insert a hydrophobic graft along the backbone of the polyurethane polymer structure 10A.

FIG. 1B depicts a portion of the second polyurethane polymer 10B that is present as part of the polyurethane binder particles described herein.

The second polyurethane polymer structure 10B in FIG. 1B includes several chemical moieties, such as urethane linkage groups 12 (formed by the reaction of isocyanate groups 14 with any of a number of polycarbonate based diols 16 that may be present). A carbon atom of an isocyanate group 14 reacts with an oxygen atom of a hydroxyl of the polycarbonate based diol 16 to form the urethane linkage group 12. The polycarbonate based diols 16 and the isocyanate groups 14 are shown schematically after polymerization. The isocyanate groups 14 are shown along the polyurethane backbone, and are schematically represented by a circle with isocyanate groups on either side thereof. Other chemical moieties represented in FIG. 1B include a hydrophobic graft diol 20. A carbon atom of an isocyanate group 14 reacts with an oxygen atom of a hydroxyl of the hydrophobic graft diol 20 to insert a hydrophobic graft along the backbone of the polyurethane polymer structure 10B. Still other chemical moieties represented in FIG. 1B include a urea group 18, formed by the reaction of isocyanate groups 14 with a mono-amino substituted sulfonic acid 24. The ends of the polyurethane polymer structure 10B in FIG. 1B may include the mono-amino substituted sulfonic acid 24 as a capping moiety. A carbon atom of the mono-amino substituted sulfonic acid 24 reacts with the amine group of the isocyanate group 14 to form a cap, which prevents further polymerization of the polyurethane polymer 10B. The cap is then a sulfonate group 26 on the end of the polyurethane polymer 10B, which is unable to further polymerize with other isocyanate groups 14 that may be present.

The polyurethane polymer structures 10A and 10B shown in FIG. 1A and FIG. 1B are not intended to depict a specific polymer, but rather show examples of the sulfonated side chain (FIG. 1A) and sulfonated capping moiety 26 (FIG. 1B). It is contemplated that the polyurethane polymer structures 10A, 10B may include additional polymerized isocyanates 14, polymerized polycarbonate based diols 16, polymerized hydrophobic graft diols 20, etc. Additionally, in the polyurethane polymer structures 10A, the sulfonated diamine 22 and the hydrophobic graft diol 20 may be in different positions along the polymer backbone depending on the respective reactions with the isocyanates 14.

The polyurethane binder particles may be synthesized by reacting the diisocyanate (where the first and second diisocyanates are the same type), the hydrophobic graft diol (where the first and second hydrophobic graft diols are the same type), the polycarbonate based diol (where the first and second polycarbonate based diols are the same type) to form a plurality of pre-polymer chains; reacting the mono-amino substituted sulfonic acid with some of the pre-polymer chains to form the second of the at least two polyurethane polymers (i.e., polyurethane polymer 10B); and reacting the sulfonated diamine with other of the pre-polymer chains to form the first of the at least two polyurethane polymers (i.e., polyurethane polymer 10A). The resulting polyurethane binder particles consist of the two polyurethane polymers 10A, 10B. The first polyurethane polymer 10A consists of the polymerized sulfonated diamine, the polymerized diisocyanate, the polymerized polycarbonate based diol, and the polymerized hydrophobic graft diol. The second polyurethane polymer 10B consists of the polymerized diisocyanate, the polymerized polycarbonate based diol, the polymerized hydrophobic graft diol, and the mono-amino substituted sulfonic acid as a capping moiety on at least one end of the polymer 10B.

In one example, making the polyurethane binder particles begins with forming the pre-polymer by reacting the diisocyanate with the polycarbonate based diol and the hydrophobic graft diol. This reaction may occur in the presence of a catalyst (e.g., dibutyl tin dilaurate, bismuth octanoate, and 1,4-diazabicyclo[2.2.2]octane) and in an organic solvent (e.g., methyl ethyl ketone (MEK), tetrahydrofuran (THF), ethyl acetate, acetone, or combinations thereof) under reflux. This reaction forms the pre-polymer claims having urethane linkages. The pre-polymer chains are dissolved in the organic solvent.

Some example diisocyanates include hexamethylene-1,6-diisocyanate (HDI), 2,2,4-trimethyl-hexamethylene-diisocyanate (TDMI), 1,12-dodecane diisocyanate, 2,4,4-trimethyl-hexamethylene diisocyanate, 2-methyl-1,5-pentamethylene diisocyanate, isophorone diisocyanate (IPDI), methylene diphenyl diisocyanate (MDI), 1-Isocyanato-4-[(4-isocyanatocyclohexyl)methyl]cyclohexane) (H12MDI, i.e., 4,4′-Methylenedicyclohexyl diisocyanate), and combinations thereof. During the initial reaction to form the pre-polymer chains, the diisocyanate is used in excess so that additional NCO groups are available for subsequent chain extension and/or cross-linking of the polyurethane polymer 10A.

Examples of suitable commercially available polycarbonate polyols are ETERNACOLL® UH200 (a solvent-free solid aliphatic polycarbonate diol from UBE Industries, Ltd.) and KURARAY® polyol C-1090 (a liquid polycarbonate polyol from Kuraray America Inc.).

In the examples disclosed herein, any hydrophobic graft diol may be used. In some examples, the hydrophobic section of the graft diol may be a polyacrylic chain. In some examples, the polyacrylic chain is polymethacrylate. In other examples, the polyacrylic chain is poly(2-ethylhexyl)acrylate. In still other examples, the polyacrylic chain includes a mixture of acrylic monomers (see formula (I) for examples). In one example, the hydrophobic grafted diol (e.g., both the first and second hydrophobic graft diols) has formula (I):

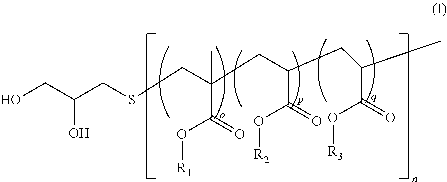

wherein:

R₁ is methyl, ethyl, propyl, butyl, pentyl, or hexyl;

R₂ is a branched alkyl group selected from the group consisting iso-propyl, 2-methylbutyl, 2-methylpentyl, 2-methylhexyl, 2-ethylbutyl, 2-ethylpentyl, 2-ethylhexyl, 2-propylbutyl, 2-propylpentyl, and 2-propylhexyl;

R₃ is (OCH₂CH₂)₂OCH₂CH₃; (OCH₂CH₂)₃OCH₂CH₃; (OCH₂CH₂)₄OCH₂CH₃; (OCH₂CH₂)₅OCH₂CH₃; (OCH₂(OCH₂CH₂)₆)OCH₂CH₃; (OCH₂CH₂)₇OCH₂CH₃; (OCH₂CH₂)₂OCH₃; (OCH₂CH₂)₃OCH₃; (OCH₂CH₂)₄OCH₃; (OCH₂CH₂)₅OCH₃; (OCH₂(OCH₂CH₂)₆)OCH₃; or (OCH₂CH₂)₇OCH₃;

o ranges from 1 to 50;

p ranges from 1 to 50;

q ranges from 1 to 50; and

n ranges from 1 to 30.

Other chain lengths for R₁, R₂, and R₃ are possible, as long as the hydrophobic grafted diol can react to generate the polyurethane polymers 10A, 10B, and does not deleteriously affect the jettability of the polyurethane particles.

One specific example of the hydrophobic graft diol of formula (I) is formula (II):

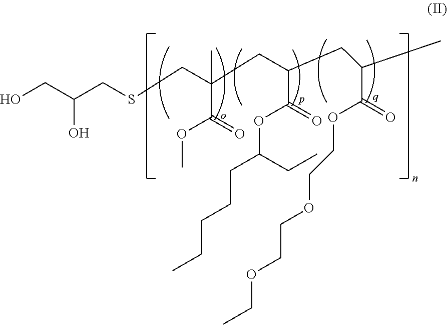

which formed from a polymerization reaction of methyl methacrylate (o ranges from 1 to 50), 2-ethylhexyl acrylate (p ranges from 1 to 50), and 2-(2-ethoxyethoxy)ethyl acrylate (q ranges from 1 to 50), and thioglycerol (which introduces the diol) in a solvent under heating in the presence of an initiator.

Any suitable solvents and heating conditions may be used for the polymerization of the hydrophobic graft diol, depending upon the monomers used. Some examples of the solvent may be benzene, toluene, xylenes, ethyl acetate, or propyl acetate.

The heating conditions for generating the hydrophobic graft diol may be 80° C. under reflux in one or more of the listed solvents.

The initiator may be a free radical initiator, such as an azo compound or a peroxide. The initiator may alternatively be any thermal initiator. Some examples of the thermal initiators include tert-amyl peroxybenzoate, 4,4-azobis(4-cyanovaleric acid), 1,1′-azobis(cyclohexanecarbonitrile) 2,2′-azobisisobutyronitrile (aibn), benzoyl peroxide, 2,2-bis(tert-butylperoxy)butane, 1,1-bis(tert-butylperoxy)cyclohexane, 2,5-bis(tert-butylperoxy)-2,5-benzene, 2,5-bis(tert-butylperoxy)-2,5-dimethyl-3-hexyne, bis(1-(tert-butylperoxy)-1-(benzemethylethyl)benzene, 1,1-bis(tert-butylperoxy)-3,3,5-85 (dibutyl phthalate) trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, or lauroyl peroxide.

The weight average molecular weight of the hydrophobic grafted diol may range from about 1,000 g/mol to about 15,000 g/mol.

Referring back to the synthesis of the polyurethane binder particles, some of the pre-polymer chains are then reacted with a mono-amino substituted sulfonic acid to form the polyurethane polymer 10B. The mono-amino substituted sulfonic acid is introduced to the pre-polymer chains before the sulfonated diamine in order to control polymerization and the overall molecular weight of the binder particles. In contrast to the sulfonated diamine (which functions as a chain extender), the mono-amino substituted sulfonic acid terminates polymerization of the pre-polymer chains with which it reacts. This generates polyurethane polymer 10B, which has a lower molecular weight than polyurethane polymer 10A. It is to be understood that the mono-amino substituted sulfonic acid is added in an amount that is smaller than the amount of diisocyanate so that some of the pre-polymer chains are capped, and other pre-polymer chains are left to react with the sulfonated diamine.

Some examples of suitable mono-amino substituted sulfonic acids are 2-aminoethanesulfonic acid (also referred to herein as taurine), N-cyclohexyl-2-aminoethanesulfonic acid (also referred to herein as CHES), N-cyclohexyl-3-aminopropanesulfonic acid (also referred to herein as CAPS), all commercially available from Sigma-Aldrich (USA).

The sulfonated diamine is then added to react with the other pre-polymer chains (e.g., those that did not react with the mono-amino substituted sulfonic acid). This reaction forms the polyurethane polymer 10A. The sulfonated diamine functions as a chain extender, growing the length of the pre-polymer chains with which it reacts. This generates polyurethane polymer 10A, which has a higher molecular weight than polyurethane polymer 10B. Any suitable sulfonated diamine may be used.

Sulfonated diamines can be prepared from diamines by adding sulfonate groups thereto. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. The list provided is to be seen as being inclusive of the types of diamines that can be used in forming the polymerized sulfonated-diamines.

Example diamine structures are shown below. More specific examples of diamines include 4,4′-methylenebis(2-methylcyclohexyl-amine) (DMDC), 4-methyl-1,3′-cyclohexanediamine (HTDA), 4,4′-Methylenebis(cyclohexylamine) (PACM), isphorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amines, and thus, is a triamine. However, since it also includes 2 amines, it is considered to fall within the definition herein of “diamine,” meaning it includes two amines. Any of the diamine structures set forth herein are modified by adding sulfonate groups thereto, which produce sulfonate group sidechains on the final polyurethane polymer 10A backbone.

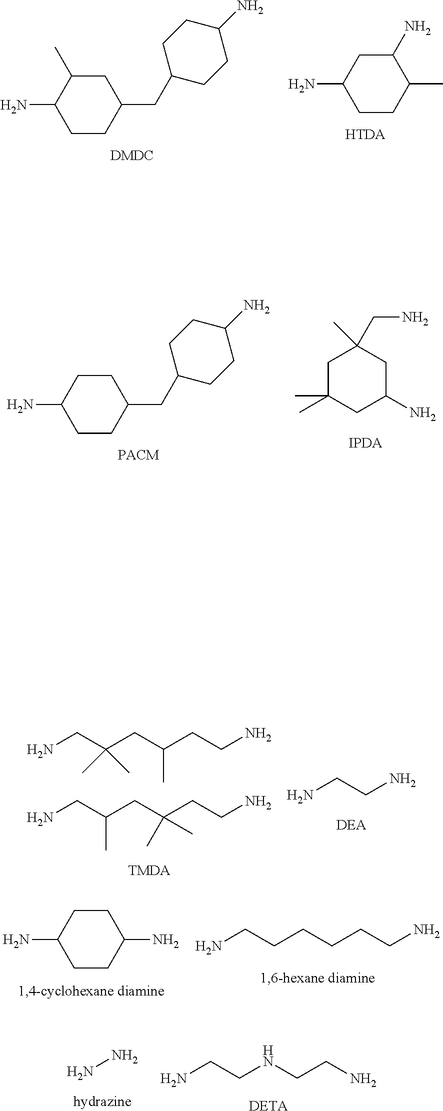

There are also other alkyl diamines (other than 1,6-hexane diamine) that can be used, such as, by way of example:

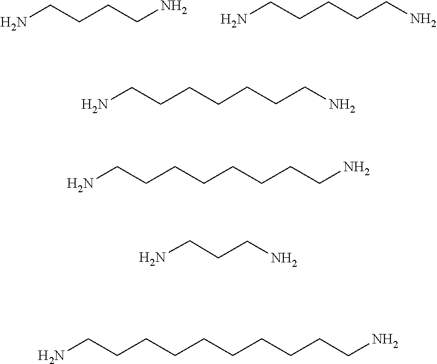 [SMILES: NCCCCN ; NCCCCCN ; NCCCCCCCN ; NCCCCCCCCN ; NCCCN ; NCCCCCCCCCCN]

There are also other dihydrazides (other than AAD shown above) that can be used, such as, by way of example:

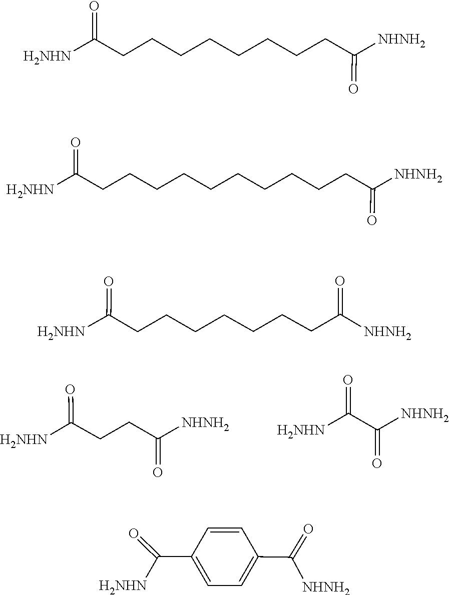

An example of the sulfonated diamine is an alkylamine-alkylamine-sulfonate (shown as a sulfonic acid in Formula 3 below, but as a sulfonate, would include a positive counterion associated with an SO₃⁻ group). While one example is shown in Formula III below, it is to be understood that other diamines may be used to generate a sulfonated diamine, including those based on structures shown above.

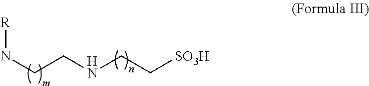

where R is H or is a C1 to C10 straight- or branched-alkyl or alicyclic or combination of alkyl and alicyclic, m is 1 to 5, and n is 1 to 5. One example of such a structure, sold by Evonik Industries (USA), is A-95, which is exemplified where R is H, m is 1, and n is 1. Another example structure sold by Evonik Industries is VESTAMIN®, where R is H, m is 1, and n is 2.

The sulfonated diamine provides the polyurethane polymer 10A with a polar stabilizing functional group, which is able to couple with polar aqueous groups (e.g., water) to form a stable dispersion that does not precipitate out.

After the cross-linking reaction (involving the sulfonated diamine and some of the pre-polymer chains), any solvent is then removed, e.g., by vacuum distillation to afford the final polyurethane dispersion (i.e., polyurethane binder particles (with polymers 10A and 10B) dispersed in water). More specifically, the polyurethane solution may be slowly added to water including a base with vigorous agitation, or vice versa. The mixture may be stirred and the organic solvent may be removed by distillation to form the polyurethane binder particles in dispersion.

In an example, the polyurethane binder particle (formed of the mixture of polyurethane polymers 10A and 10B) has an acid number of 61 or less and a particle size ranging from about 10 nm to about 100 nm.

In an example, the acid number of the polyurethane binder particle is 60 mg KOH/g solid resin or less, or 55 mg KOH/g solid resin or less. As examples, the polyurethane binder particle may have an acid number ranging from greater than 0 mg KOH/g to 60 mg KOH/g, or from greater than 10 mg KOH/g to about 50 mg KOH/g, or from greater than 20 mg KOH/g to about 40 mg KOH/g, or from greater than 25 mg KOH/g to about 35 mg KOH/g, etc. As used herein, the term “acid number” refers to the mass of potassium hydroxide (KOH) in milligrams that is used to neutralize one (1) gram of a particular substance (e.g., the polyurethane binder particles). The test for determining the acid number of a particular substance may vary, depending on the substance. For example, to determine the acid number of the polyurethane binder particles, a known amount of a sample of the polyurethane binder particles may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used

The average particle size (volume-weighted mean diameter) of the polyurethane binder particles may range from about 10 nm to about 100 nm. In one example, this range refers to the D50 particle size of a particle distribution (half of the particles in the distribution are above the D50 value and half the particle in the distribution are below the D50 value). In an example, the polyurethane binder particles may have a D50 particle size ranging from about 10 nm to about 100 nm.

The polyurethane binder particle also has a weight average molecular weight ranging from about 5,000 g/mol to about 50,000 g/mol. In other examples, the polyurethane binder particle has a weight average molecular weight ranging from about 10,000 g/mol to about 30,000 g/mol or from about 15,000 g/mol to about 25,000 g/mol.

The polyurethane binder particles may be incorporated into the inkjet ink as a polyurethane dispersion, and any liquid components of the dispersion become part of the aqueous vehicle. The polyurethane dispersion has a solid content from about 10% to about 40%.

The polyurethane dispersion is added in a suitable amount so that the desired solids content of polyurethane binder particles is achieved in the inkjet ink. In an example, the polyurethane binder particles (which does not account for other dispersion components) are present in an amount ranging from about 0.1 wt % active to about 20 wt % active based on a total weight of the inkjet ink. In other examples, the polyurethane binder particles are present in an amount ranging from about 1 wt % active to about 20 wt % active, or from about 5 wt % active to about 18 wt % active, or from about 10 wt % active to about 14 wt % active, or from about 0.1 wt % to about 10 wt % active, or from about 0.5 wt % to about 7 wt % based on the total weight of the inkjet ink.

The polyurethane binder particles may be formed from any of the example isocyanates, polycarbonate based polyols, grafted diols, sulfonated diamines, and mono-amino substituted sulfonic acid set forth herein. Table A illustrates some examples of the components used to make different examples of the binder particles. Table B illustrates the properties of the example binder particle dispersions.

The following abbreviations are used in Tables A and B: PUD=polyurethane dispersion; IPDI=Isophorone diisocyanate; HGD=formula II, wherein o=22, p=2, and q=2 (hydrophobic graft diol with a weight average molecular weight of about 3,000 g/mol); PCP=polycarbonate polyol; CHES=2-(N-cyclohexylamino) ethane sulfonic acid; CAPS=3-cyclohexyl-1-propylsulfonic acid; and A-95=a sulfonated diamine (sodium aminoalklysulphonate from Evonik Industries).

TABLE A

| Binder | IPDI | | PCP | Taurine | CHES | CAPS | A-95 |
|---|---|---|---|---|---|---|---|
| Particles | (%) | HGD (%) | (%) | (%) | (%) | (%) | (%) |
| PUD-A | 26.092 | 42.721 | 13.807 | 4.86 | — | — | 12.394 |
| PUD-B | 27.76 | 43.813 | 14.16 | 2.557 | — | — | 12.711 |
| PUD-C | 26.251 | 42.98 | 13.89 | 2.508 | — | — | 14.37 |
| PUD-D | 25.271 | 41.376 | 13.372 | — | 7.977 | — | 12 |
| PUD-E | 26.321 | 43.095 | 13.927 | — | 4.154 | — | 12.502 |
| PUD-F | 25.829 | 42.289 | 13.667 | — | 4.076 | — | 14.139 |
| PUD-G | 25.136 | 41.154 | 13.3 | — | — | 8.471 | 11.939 |
| PUD-H | 26.247 | 42.974 | 13.888 | — | — | 4.423 | 12.467 |
| PUD-I | 25.758 | 42.173 | 13.629 | — | — | 4.34 | 14.1 |

TABLE B

| | Total | Particle | | |
|---|---|---|---|---|
| | Solids | Size | | |
| Binder | (%) | (d) (nm) | pH | AN |
| PUD-A | 21.9 | 36.74 | 9.5 | 58.9 |
| PUD-B | 25.74 | 13.2 | 9.5 | 48.9 |
| PUD-C | 24.86 | 11.54 | 9 | 53.6 |
| PUD-D | 25.6 | 42.17 | 9.5 | 57 |
| PUD-E | 27.6 | 11.42 | 9.5 | 48.1 |
| PUD-F | 27.62 | 11.58 | 9.5 | 52.7 |
| PUD-G | 25.32 | 47.56 | 9.5 | 56.4 |
| PUD-H | 26.58 | 44.72 | 9 | 48 |
| PUD-I | 25.9 | 47.3 | 9.5 | 52.6 |

The inkjet ink includes a pigment. The pigment may be incorporated into the ink vehicle to form the inkjet ink. The pigment may be incorporated as a pigment dispersion. The pigment dispersion may include a pigment and a separate pigment dispersant.

For the pigment dispersions disclosed herein, it is to be understood that the pigment and separate pigment dispersant (prior to being incorporated into the ink vehicle to form the inkjet ink), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the pigment dispersion become part of the aqueous vehicle in the inkjet ink.

As used herein, “pigment” generally includes organic or inorganic pigment colorants, magnetic particles, aluminas, silicas, and/or other ceramics, organo-metallics or other opaque particles, whether or not such particulates impart color. Thus, although the present description primarily illustrates the use of pigment colorants, the term “pigment” can be used more generally to describe pigment colorants, as well as other pigments, such as organometallics, ferrites, ceramics, etc.

In some examples, the pigment may be a cyan, magenta, black or yellow pigment.

Examples of suitable pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific examples of a cyan color pigment may include C.I. Pigment Blue-1, -2, -3, -15, -15:1, -15:2, -15:3, -15:4, -16, -22, and -60.

Specific examples of a magenta color pigment may include C.I. Pigment Red-5, -7, -12, -48, -48:1, -57, -112, -122, -123, -146, -168, -177, -184, -202, and C.I. Pigment Violet-19.

Specific examples of black pigment include carbon black pigments. An example of an organic black pigment includes aniline black, such as C.I. Pigment Black 1.

Specific examples of a yellow pigment may include C.I. Pigment Yellow-1, -2, -3, -12, -13, -14, -16, -17, -73, -74, -75, -83, -93, -95, -97, -98, -114, -128, -129, -138, -151, -154, and -180.

While several examples have been given herein, it is to be understood that any other pigment or dye can be used that is useful in modifying the color of the inkjet ink.

As noted, the pigment may initially be present in a water-based dispersion. The pigment dispersion may then be incorporated into the ink aqueous vehicle so that the pigment is present in an active amount that is suitable for the inkjet printing architecture that is to be used. In an example, the pigment dispersion is incorporated into the aqueous vehicle so that the pigment is present in an amount ranging from about 0.5 wt % active to about 15 wt % active, based on a total weight of the inkjet ink. In other examples, the pigment dispersion is incorporated into the ink vehicle so that the pigment is present in an amount ranging from about 5 wt % active to about 10 wt % active, or from about 11 wt % active to about 15 wt % active, based on a total weight of the inkjet ink. In still another example, the pigment dispersion is incorporated into the ink vehicle so that the pigment is present in an amount of about 4 wt % active or about 6 wt % active, based on a total weight of the inkjet ink.

The inkjet ink also includes an ink aqueous vehicle. As used herein, the term “ink aqueous vehicle” may refer to the liquid with which the polyurethane binder particle (dispersion) and the pigment (dispersion) are mixed to form a thermal or a piezoelectric inkjet ink composition. A wide variety of vehicles may be used with the ink composition(s) of the present disclosure. The ink aqueous vehicle may include water and any of: a co-solvent, a surfactant, an anti-kogation agent, an anti-decel agent, an antimicrobial agent, a viscosity modifier, a pH adjuster, a chelating agent, a wax, or combinations thereof. In an example of the inkjet ink 14, the ink aqueous vehicle consists of water. In another example, the vehicle consists of water and the co-solvent, the anti-kogation agent, the anti-decel agent, the surfactant, the antimicrobial agent, the viscosity modifier, the pH adjuster, or a combination thereof. In still another example, the aqueous vehicle consists of water or water, a co-solvent and an additive selected from the group consisting of a surfactant, an anti-kogation agent, an anti-decel agent, an antimicrobial agent, a viscosity modifier, a pH adjuster, a chelating agent, a wax, and combinations thereof.

The co-solvent, when included in the inkjet ink aqueous vehicle, may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., Dowanol™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent(s), when included, may be present in the inkjet ink in an amount ranging from about 0.1 wt % to about 60 wt % (based on the total weight of the inkjet ink). In some examples, the co-solvent(s) may range from about 1 wt % to about 30 wt % based on the total weight of the inkjet ink. In another example, the co-solvent(s) may range from about 5 wt % to about 20 wt % based on the total weight of the inkjet ink. In an example, the total amount of co-solvent(s) present in the inkjet ink is about 10 wt % (based on the total weight of the inkjet ink).

The surfactant, when included in the inkjet ink, may be any non-ionic surfactant or anionic surfactant.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

More specific examples of non-ionic surfactant include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK Additives and Instruments).

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate.

In any of the examples disclosed herein, the surfactant may be present in the inkjet ink in an amount ranging from about 0.01 wt % active to about 5 wt % active (based on the total weight of the inkjet ink). In an example, the surfactant is present in the inkjet ink in an amount ranging from about 0.05 wt % active to about 3 wt % active, based on the total weight of the inkjet ink. In another example, the surfactant is present in the inkjet ink in an amount of about 0.3 wt % active, based on the total weight of the inkjet ink.

An anti-kogation agent may also be included in the inkjet ink aqueous vehicle. Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the inkjet ink. The anti-kogation agent(s) may be present in the inkjet ink in a total amount ranging from about 0.1 wt % active to about 1.5 wt % active, based on the total weight of the inkjet ink. In an example, the anti-kogation agent(s) is/are present in an amount of about 0.5 wt % active, based on the total weight of the inkjet ink.

Examples of suitable anti-kogation agents include oleth-3-phosphate (commercially available as CRODAFOS™ O3A or CRODAFOS™ N-3A), oleth-5-phosphate (commercially available as CRODAFOS™ 05 A), or dextran 500 k. Other suitable examples of the anti-kogation agents include CRODAFOS™ HCE (phosphate-ester from Croda Int.), CRODAFOS™ CES (phosphate-based emulsifying and conditioning wax from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The inkjet ink may also include anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the inkjet ink. An example of a suitable anti-decel agent is ethoxylated glycerin having the following formula:

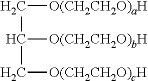

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The anti-decel agent(s) may be present in an amount ranging from about 0.2 wt % active to about 5 wt % active (based on the total weight of the inkjet ink). In an example, the anti-decel agent is present in the inkjet ink in an amount of about 1 wt % active, based on the total weight of the inkjet ink.

The vehicle of the inkjet ink may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Other suitable antimicrobial agents include naticide, levulinic acid, polixetonium chloride, 2-phenylethanol, salicylic acid, sodium dehydroaceate, and 4-methoxybenzoic acid.

In an example, the total amount of antimicrobial agent(s) in the inkjet ink ranges from about 0.01 wt % active to about 0.05 wt % active (based on the total weight of the inkjet ink). In another example, the total amount of antimicrobial agent(s) in the inkjet ink is about 0.044 wt % active (based on the total weight of the inkjet ink).

The ink vehicle may also include a viscosity modifier(s). The viscosity modifier may be added to adjust the viscosity of the inkjet ink and to aid in redispersibility of the inkjet ink after it has sat idle. Examples of suitable viscosity modifiers include boehmite, laponite, anionic cellulose (e.g., carboxymethyl cellulose, cellulose sulfate, nitrocellulose, and combinations thereof), and combinations thereof.

In an example, the total amount of viscosity modifier(s) in the inkjet ink ranges from about 0.005 wt % active to about 5 wt % active (based on the total weight of the inkjet ink).

The ink vehicle may also include pH adjuster(s). The type and amount of pH adjuster that is added may depend upon the initial pH of the inkjet ink and the desired final pH of the inkjet ink. If the initial pH is too high (e.g., above 12), an acid may be added to lower the pH, and if the initial pH is too low (below 7.5), a base may be added increase the pH. Examples of suitable pH adjusters include metal hydroxide bases, such as potassium hydroxide (KOH), sodium hydroxide (NaOH), etc. In an example, the metal hydroxide base may be added to the inkjet ink in an aqueous solution. In another example, the metal hydroxide base may be added to the inkjet ink in an aqueous solution including 5 wt % of the metal hydroxide base (e.g., a 5 wt % potassium hydroxide aqueous solution). Any of the acidic pH adjusters mentioned herein may also be used.

In an example, the total amount of pH adjuster(s) in the inkjet ink ranges from greater than 0 wt % to about 0.1 wt % (based on the total weight of the inkjet ink). In another example, the total amount of pH adjuster(s) in the inkjet ink is about 0.03 wt % (based on the total weight of the inkjet ink).

A chelating agent may also be included in the inkjet ink aqueous vehicle. A chelating agent may be used to bond with or otherwise interact with another atom or molecule (e.g., metal ions or molecules), and may prevent that atom or molecule from interacting or reacting with other chemically active species in a solution. When included, the chelating agent is present in an amount greater than 0 wt % active and less than or equal to 0.5 wt % active based on the total weight of the inkjet ink. In an example, the chelating agent is present in an amount ranging from about 0.05 wt % active to about 0.2 wt % active based on the total weight of the inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

A wax may also be included in the inkjet ink aqueous vehicle. In some examples, the wax is a wax emulsion. As a specific example, the wax is a polyethylene (PE) wax emulsion. The PE wax emulsion includes a polyethylene (PE) wax. The polyethylene wax emulsion may help to reduce agglomerate formation in thermal inkjet printhead nozzles both during storage and printing. In some examples, the polyethylene wax emulsion has an average particle size that is less than 50 nm. An example of a suitable wax emulsion is LIQUILUBE® 405, available from Lubrizol.

In some examples, the wax can be present in an amount ranging from about 0.2 wt % active to about 2.5 wt % active, based on the total weight of the inkjet ink. In some other examples, the wax can be present in an amount ranging from about 0.3 wt % active to about 2 wt % active. In some other examples, the wax can be present in an amount ranging from about 0.5 wt % active to about 1 wt % active. The PE wax emulsion may be present in the inkjet ink in an amount ranging from about 0.1 wt % active to about 1.5 wt % active (based on the total weight of the ink).

The balance of the inkjet ink aqueous vehicle is water. As such, the weight percentage of the water present in the inkjet ink will depend, in part, upon the weight percentages of the other components. The water may be purified water or deionized water. In some examples, the aqueous vehicle is present in an amount of at least 30 wt %. In other examples, the aqueous vehicle is present in an amount of greater than 30 wt % based on a total weight of the inkjet ink, such as greater than 40 wt %, greater than 50 wt %, or greater than 60 wt %. In an example, the water may be present in an amount of up to 95 wt % based on the total weight of the inkjet ink.

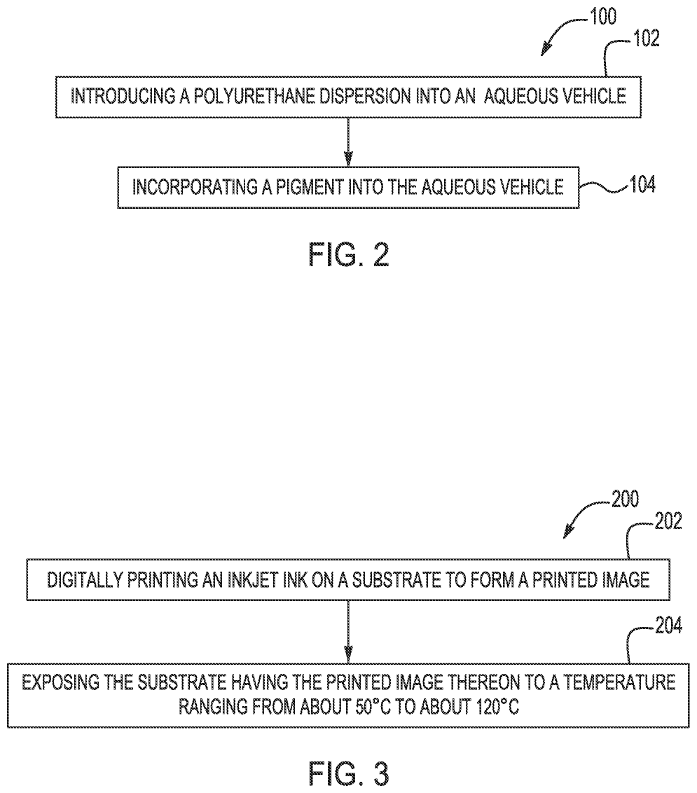

FIG. 2 describes a method of making an example of the inkjet ink disclosed herein. In this example, the method 100 includes introducing a polyurethane dispersion into an aqueous vehicle, the polyurethane dispersion including: a polyurethane binder particle including at least two polyurethane polymers 10A, 10B, wherein: a first (polymer 10A) of the at least two polyurethane polymers has a first backbone chain formed from a first diisocyanate, a first hydrophobic graft diol, a first polycarbonate based diol, and a sulfonated diamine; and a second (polymer 10B) of the at least two polyurethane polymers has a second backbone chain formed from a second diisocyanate, a second hydrophobic graft diol, and a second polycarbonate based diol, and includes a mono-amino substituted sulfonic acid as its capping moiety; and water (shown generally at reference numeral 102); and incorporating a pigment into the aqueous vehicle (reference numeral 104).

The polyurethane binder particle may be any of the examples listed above. The pigment may be any of the example pigments listed above. The aqueous ink vehicle may also be any of the examples listed above.

The inkjet ink may have a total solids content ranging from about 0.6% to about 35%.

Fixer Fluid

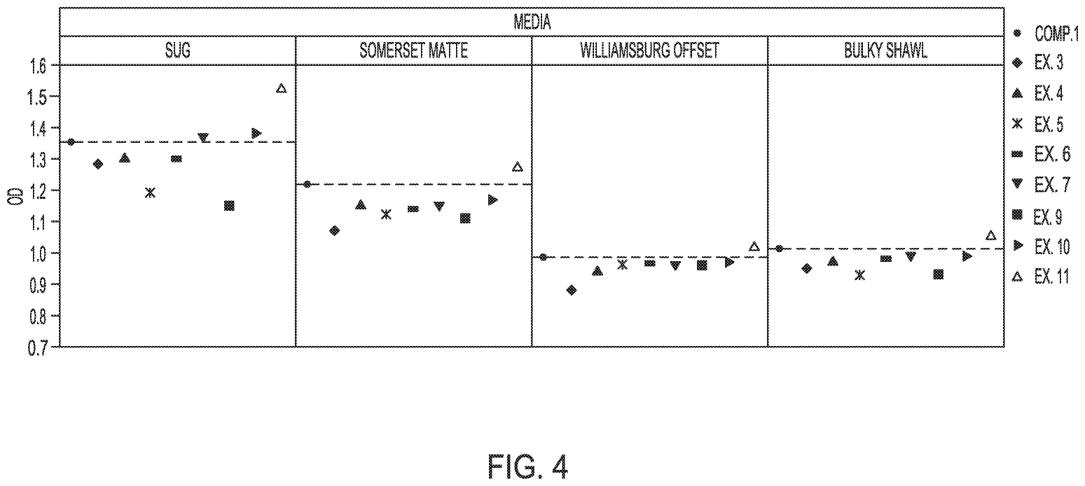

In an example of printing method (shown in FIG. 3), a fixer fluid may be applied to the substrate before the inkjet ink. The composition of the fixer fluid includes a multivalent metal salt and an aqueous vehicle.

In some examples, the fixer fluid consists of the multivalent metal salt and the aqueous vehicle. In other examples, the fixer fluid may include additional components.

Some examples of the fixer fluid disclosed herein may be used in a thermal inkjet printer or in a piezoelectric printer. The viscosity of the fixer fluid composition may be adjusted for the type of printhead that is to be used, and the viscosity may be adjusted by adjusting the co-solvent level and/or adding a viscosity modifier. When used in a thermal inkjet printer, the viscosity of the fixer fluid may be modified to range from about 1 cP to about 9 cP (at 20° C. to 25° C.), and when used in a piezoelectric printer, the viscosity of the fixer fluid may be modified to range from about 2 cP to about 20 cP (at 20° C. to 25° C.), depending on the type of the printhead that is being used (e.g., low viscosity printheads, medium viscosity printheads, or high viscosity printheads).

The multivalent metal salt includes a multivalent metal cation and an anion. In an example, the multivalent metal salt includes a multivalent metal cation selected from the group consisting of a calcium cation, a magnesium cation, a zinc cation, an iron cation, an aluminum cation, and combinations thereof; and an anion selected from the group consisting of a chloride anion, an iodide anion, a bromide anion, a nitrate anion, a carboxylate anion, a sulfonate anion, a sulfate anion, and combinations thereof. In one specific example, the multivalent metal includes a calcium cation. In another example, the multivalent metal includes a calcium cation; and an anion selected from the group consisting of a chloride anion, an iodide anion, a bromide anion, a nitrate anion, a carboxylate anion, a sulfonate anion, a sulfate anion, and combinations thereof.

It is to be understood that the multivalent metal salt (containing the multivalent metal cation) may be present in any suitable amount. In an example, the metal salt is present in an amount ranging from about 2 wt % to about 20 wt % based on a total weight of the fixer fluid. In further examples, the metal salt is present in an amount ranging from about 4 wt % to about 12 wt %; or from about 5 wt % to about 15 wt %; or from about 6 wt % to about 10 wt %, based on a total weight of the fixer fluid.

As mentioned above, the fixer fluid also includes an aqueous vehicle. As used herein, the term “aqueous vehicle” may refer to the liquid in which the multivalent metal salt is mixed to form the fixer fluid.

In an example of the fixer fluid, the aqueous vehicle includes a surfactant, a co-solvent, and a balance of water. In another example, the fixer fluid further comprises an additive selected from the group consisting of a chelating agent, an antimicrobial agent, an anti-kogation agent, a pH adjuster, and combinations thereof.

Some examples of the fixer fluid include a surfactant, a co-solvent, a chelating agent, an antimicrobial agent, and/or an anti-kogation agent. In these examples, the fixer fluid may include any of the examples of the surfactant, the co-solvent, the chelating agent, the antimicrobial agent, and/or the anti-kogation agent described above in reference to the aqueous vehicle of the inkjet ink. In these examples, the fixer fluid may also include any of the surfactant, the co-solvent, the chelating agent, the antimicrobial agent, and/or anti-kogation agent described above in reference to the liquid vehicle of the inkjet ink (with the amount(s) being based on the total weight of the fixer fluid rather than the total weight of the inkjet ink).

A pH adjuster may also be included in the fixer fluid. A pH adjuster may be included in the fixer fluid to achieve a desired pH (e.g., 6) and/or to counteract any slight pH increase that may occur over time. In an example, the total amount of pH adjuster(s) in the fixer fluid ranges from greater than 0 wt % to about 0.1 wt % (based on the total weight of the fixer fluid). In another example, the total amount of pH adjuster(s) in the fixer fluid is about 0.03 wt % (based on the total weight of the fixer fluid).

An example of a suitable pH adjuster that may be used in the fixer fluid includes methane sulfonic acid, any other acidic pH adjuster, or any of the pH adjusters set forth for the inkjet ink.

Suitable pH ranges for examples of the fixer fluid can be from pH 4 to less than pH 9, from pH 5 to pH 8, or from pH 5.5 to pH 7. In one example, the pH of the fixer fluid is pH 6.

The balance of the fixer fluid is water. As such, the weight percentage of the water present in the fixer fluid will depend, in part, upon the weight percentages of the other components. The water may be purified water or deionized water.

Substrate

The inkjet ink disclosed herein may be particularly suitable for absorptive media, such as plain paper, enhanced paper, coated paper, or any other porous media. In an example, the substrate is selected from the group consisting of coated paper and uncoated paper.

As used herein, “plain paper” refers to paper that has not been specially coated or designed for specialty uses (e.g., photo printing). Plain paper is composed of cellulose fibers and fillers. In contrast to an enhanced paper (described below), plain paper does not include an additive that produces a chemical interaction with a pigment in an ink that is printed thereon.

Also as used herein, “enhanced paper” refers to paper that has not been specially coated, but does include the additive that produces a chemical interaction with a pigment in an ink that is printed thereon. The enhanced paper is composed of cellulose fibers, fillers, and the additive. An example of the additive is calcium chloride or another salt that instantaneously reacts with an anionic pigment present in the ink printed on the enhanced paper, which causes the pigment to crash out of the ink and fixes the pigment on the enhanced paper surface. As an example, the enhanced paper may be any standard paper that incorporates COLORLOK® Technology (International Paper Co.). Both plain paper and enhanced paper are commercially available as general office printer and/or copier papers, but, as previously mentioned, the enhanced paper incorporates the COLORLOK® Technology. Examples of plain paper used herein include Georgia-Pacific Spectrum Multipurpose paper (from Georgia-Pacific), Hammermill Great White 30 (from Hammermill), Williamsburg 50 #White Smooth Offset Plus (from International Paper), and an uncoated paper available from Pegasus.

An example of enhanced paper used herein is HP® Multipurpose paper media with COLORLOK® technology (from HP Development Company).

In some examples, the substrate may be coated paper. In these examples, the paper substrate may have an ink receiving layer that interacts with the inkjet ink. Some commercially available examples are Sterling Ultra Gloss (SUG #80, an offset coated media from Verso Corporation), 80 #Opus Gloss and Somerset matte 70 #, both available from Sappi Lmtd.

Sets and Kits

In examples described herein, the inkjet ink may be included in an ink set, with one or more other colored inks and/or with the fixer fluid. In one specific example, the inkjet ink is included in an ink set with the fixer fluid. In some examples, several inks may be included together as an ink set to be used in an inkjet printer. In one specific example, the ink set may include a black ink, a cyan ink, a yellow ink, and a magenta ink, each of which is formulated with the polyurethane polymer particles disclosed herein. This ink set may also include a fixer fluid. Other ink sets may include more colors, or fewer colors, as is desirable.

In other examples, one or more of the inkjet inks and the fixer fluid disclosed herein may be included with the substrate as a printing kit to be used with an inkjet printer.

Printing Method and System

FIG. 3 depicts an example of the printing method 200. As shown in FIG. 3, an example of the printing method 200 comprises: digitally printing an inkjet ink on a substrate to form a printed image, the inkjet ink including: a polyurethane binder particle including at least two polyurethane polymers, wherein: a first of the at least two polyurethane polymers has a first backbone chain formed from a first diisocyanate, a first hydrophobic graft diol, a first polycarbonate based diol, and a sulfonated diamine; and a second of the at least two polyurethane polymer has a second backbone chain formed from a second diisocyanate, a second hydrophobic graft diol, and a second polycarbonate based diol, and includes a mono-amino substituted sulfonic acid as its capping moiety; a pigment; and an aqueous vehicle (shown generally at reference numeral 202); and exposing substrate having the printed image thereon to a temperature ranging from about 50° C. to about 120° C. (shown at reference numeral 204).

It is to be understood that any example of the inkjet ink may be used in the examples of the method 200. Further, it is to be understood that any example of the substrate may be used in the examples of the method 200.

In some example methods, the inkjet ink is applied directly to the substrate. In this method, the inkjet ink may be applied via a digital inkjet printing method. As examples, the inkjet ink may be applied using piezoelectric inkjet printing or thermal inkjet printing. Any suitable inkjet applicator, such as a thermal inkjet printhead, a piezoelectric printhead, a continuous inkjet printhead, etc. may be used. In some examples, the digital printing of the inkjet ink is performed with a thermal inkjet printer.

In other example methods, the fixer fluid is applied directly to the substrate, and the inkjet ink is applied to the fixer fluid while the fixer fluid is wet, i.e. wet-on-wet printing. In an example of this method, the fixer fluid may be applied via a digital inkjet printing method. Any suitable inkjet applicator, such as a thermal inkjet printhead, a piezoelectric printhead, a continuous inkjet printhead, etc. may be used. In some examples, the digital printing of the fixer fluid is performed via a digital inkjet printing method. In some examples, the fixer fluid and the inkjet ink may be printed with a thermal inkjet printer.

In these examples, the fixer fluid is applied in an amount ranging from about 2 gsm to about 20 gsm.

The inkjet ink may be applied on all or substantially all of the substrate having the fixer fluid thereon. In these examples, the layer of the fixer fluid and the inkjet ink that is formed may be a continuous layer that covers all or substantially all of the substrate. In other examples, the fixer fluid and the inkjet ink may be applied on areas of the substrate where it is desirable to form a printed image. In these examples, the layer of the fixer fluid and/or the inkjet ink that is formed may be non-continuous (e.g., may contain gaps) because the fixer fluid and/or the inkjet ink may not be printed on areas of the substrate where it is not desirable to form the printed image.

In an example, the inkjet ink is applied in an amount ranging from about 2 gsm to about 30 gsm. In another example, the inkjet ink is applied in an amount ranging from about 15 gsm to about 20 gsm.

In some examples, multiple inkjet inks may be inkjet printed onto the substrate. In these examples, each of the inkjet inks may include a pigment, an example of the polyurethane binder particles, and the ink vehicle. Each of the inkjet inks may include a different colored pigment so that a different color (e.g., cyan, magenta, yellow, black, violet, green, brown, orange, purple, etc.) is generated by each of the inkjet inks. In other examples, a single inkjet ink 14 may be inkjet printed onto the substrate.

The inkjet printing of the inkjet ink, and the fixer fluid when used, may be accomplished at high printing speeds. In an example, the inkjet printing of the inkjet ink, and the fixer fluid when used, may be accomplished at a printing speed of at least 25 feet per minute (fpm). In another example, the inkjet ink, and the fixer fluid when used, may be inkjet printed at a printing speed ranging from 100 fpm to 1000 fpm.

As shown in reference numeral 204 in FIG. 3, the method 200 includes exposing the substrate (having the printed image thereon) to a temperature ranging from about 50° C. and 120° C. Heating at these temperatures can cure the polyurethane binder particles so that they form a film on the substrate surface, which increases the printed image durability. The thermal curing may be accomplished by applying heat to the substrate. In an example of the method 200, the heating step involves heating the substrate (having the printed image thereon) to a temperature ranging from about 50° C. to about 120° C., for a period of time ranging from about 10 seconds to about 15 minutes. In another example, the temperature ranges from about 70° C. to about 110° C.

This process forms the printed image.

To further illustrate the present disclosure, an example is given herein. It is to be understood that this example is provided for illustrative purposes and is not to be construed as limiting the scope of the present disclosure.

### Example

A comparative black inkjet ink (Comp. Ex. 1) was prepared with comparative carboxylated and sulfonated polyurethane binder particles. The comparative carboxylated and sulfonated polyurethane binder particles (CPBP1) were prepared as follows:

43.66 g of polypropylene glycol (MW 1000), 192.58 g of polyol 53 (DSM 16047, TS 70.1%), 12.21 g of dimethylol propionic acid (DMPA, a carboxylated diol), and 68 g of extra dry acetone (>99.8%, urethane grade) were mixed in a 2000 ml of 4-neck round bottom flask. 75.9 g of isophorone diisocyanate (IPDI) and 20 g of dry acetone (urethane grade) was added to the flask. A mechanical stirrer with glass rod and TEFLON® blade were attached. A condenser was also attached. The flask was immersed in a constant temperature bath at 65° C. The system was kept under a dry nitrogen blanket. 12 drops (about 0.32 g) of bismuth-based catalyst (warmed in 50° C. oven first) was added to initiate the polymerization. Polymerization was continued for about 6 hours at 65° C. Another 12 drops of bismuth-based catalyst was added after 6 hours. 0.5 g samples were withdrawn for % NCO titration every hour to monitor the reaction until the NCO % dropped to 4.4 to 4.6% (theoretical % NCO should be 4.65%). This formed the comparative pre-polymer solution.

The batch temperature was reduced to 40° C. 134 g of acetone was added to dilute the comparative pre-polymer solution. The solution was heated to 40° C. 66.52 g of A-95 solution (50% Solid) without dilution was added over 30 seconds under vigorous stirring. 20 g of deionized water was added within 1 minute under vigorous stirring. The batch temperature was maintained at 42-45° C. for another 20 minutes. The solution turned viscous and semi-transparent.

11.35 g of KOH (45%) and 22.7 g of water were mixed in a beaker and added to the pre-polymer solution. Mixing was continued for 20 minutes. 851 g of D.I. water was pumped to the polymer mixture over 15 to 30 minutes at 45-50° C. The agitation was continued for at least 60 minutes at 45-50° C. Acetone was removed with rotorvap at 55° C. The final CPBP1 dispersion was filtered through 400 mesh and fiber glass filter paper. The particle size measured by Malvern Zetasizer was 25.8 nm. The pH was 10.3. The solid content was 27.5%.

Ten different example black inkjet inks (Ex. 2 through Ex. 11) were also prepared. These inks were prepared with different examples of the polyurethane binder particles (PBP2 through PBP11) disclosed herein.

PBP2 was prepared as follows:

13.807 g of polycarbonate polyol (KURARAY® C-1090, MW 1000), the hydrophobic graft polyol of formula II, wherein o=22, p=2, and q=2 (60.943 g, 72.52% in ethyl acetate), and 26.860 g of isophorone diisocyanate (IPDI) in 42 g of acetone were mixed in a 500 ml of 4-neck round bottom flask. A mechanical stirrer with glass rod and TEFLON® blade were attached. A condenser was also attached. The flask was immersed in a constant temperature bath at 60° C. The system was kept under a drying tube. 3 drops of dibutyltin dilaurate (DBTDL) was added to initiate the polymerization. Polymerization was continued for 3 hours at 60° C. 0.5 g samples were withdrawn for % NCO titration to confirm the reaction. The measured NCO value was 6.60% (theoretical % NCO should be 6.65%). This formed the pre-polymer solution.

Then, 4.986 g of taurine in 20 g of deionized water was added and stirred for 2 hours, followed by the addition of 3.337 g of 50% sodium hydroxide aqueous solution. This reaction formed some of the polyurethane polymer chains 10B in the solution.

Then, 24.788 g of sodium aminoalklysulphonate (A-95, 50% in water) and 61.969 g of deionized water were mixed in a beaker until the A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 141.703 g of cold deionized water was added to the pre-polymer solution in 4-neck round bottom flask over 10 minutes with good agitation to form the final PBP2 dispersion. The agitation was continued for 60 minutes at 40° C. The PBP2 dispersion was filtered through 400 mesh stainless sieve. Acetone was removed with rotorvap at 40° C. (2 drops (20 mg) of BYK-011 de-foaming agent was added). The final PBP2 dispersion was filtered through fiber glass filter paper. The particle size measured by Malvern Zetasizer was 36.74 nm. The pH was 9.5. The solid content was 21.19%.

PBP3 was prepared as follows:

14.160 g of polycarbonate polyol (KURARAY® C-1090, MW 1000), the hydrophobic graft polyol of formula II, wherein o=22, p=2, and q=2 (62.501 g, 72.52% in ethyl acetate), and 26.760 g of isophorone diisocyanate (IPDI) in 42 g of acetone were mixed in a 500 ml of 4-neck round bottom flask. A mechanical stirrer with glass rod and a TEFLON® blade were attached. A condenser was also attached. The flask was immersed in a constant temperature bath at 60° C. The system was kept under a drying tube. 3 drops of DBTDL were added to initiate the polymerization. Polymerization was continued for 3 hours at 60° C. 0.5 g samples were withdrawn for % NCO titration to confirm the reaction. The measured NCO value was 7.60% (theoretical % NCO should be 7.66%). This formed the pre-polymer solution.

Then, 2.557 g of taurine in 20 g of deionized water was added and stirred for 2 hours, followed by the addition of 1.711 g of 50% sodium hydroxide aqueous solution. This reaction formed some of the polyurethane polymer chains 10B in the solution.

Then, 25.442 g of sodium aminoalklysulphonate (A-95, 50% in water) and in 63.554 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 139.969 g of cold deionized water was added to polymer mixture in 4-neck round bottom flask over 10 minutes with good agitation to form the PBP3 dispersion. The agitation was continued for 60 minutes at 40° C. The PBP3 dispersion was filtered through 400 mesh stainless sieve. Acetone was removed with rotorvap at 40° C. (2 drops (20 mg) of BYK-011 de-foaming agent was added). The final PBP3 dispersion was filtered through fiber glass filter paper. The particle size measured by Malvern Zetasizer was 13.2 nm. The pH was 9.5. The solid content was 25.74%.

PBP4 was prepared as follows:

13.890 g of polycarbonate polyol (KURARAY® C-1090, MW 1000), the hydrophobic graft polyol of formula II, wherein o=22, p=2, and q=2 (61.313 g, 72.52% in ethyl acetate), and 26.251 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL were added to initiate the polymerization. Polymerization was continued for 3 hours at 60° C. 0.5 g samples were withdrawn for % NCO titration to confirm the reaction. The measured NCO value was 7.60% (theoretical % NCO should be 7.66%). This formed the pre-polymer solution.

Then, 2.508 g of taurine in 20 g of deionized water was added and stirred for 2 hours, followed by the addition of 1.679 g of 50% sodium hydroxide aqueous solution. This reaction formed some of the polyurethane polymer chains 10B in the pre-polymer solution.

Then, 28.740 g of sodium aminoalklysulphonate (A-95, 50% in water) and in 71.850 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 133.688 g of cold deionized water was added to polymer mixture in 4-neck round bottom flask over 10 minutes with good agitation to form the PBP4 dispersion. The agitation was continued for 60 minutes at 40° C. The PBP4 dispersion was filtered through 400 mesh stainless sieve. Acetone was removed with rotorvap at 40° C. (2 drops (20 mg) of BYK-011 de-foaming agent was added). The final PBP4 dispersion was filtered through fiber glass filter paper. The particle size measured by Malvern Zetasizer was 11.54 nm. The pH was 9.0. The Solid content was 24.86%.

PBP5 was prepared as follows:

13.372 g of polycarbonate polyol (KURARAY® C-1090, MW 1000), the hydrophobic graft polyol of formula II, wherein o=22, p=2, and q=2 (59.025 g, 72.52% in ethyl acetate), and 25.271 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL was added to initiate the polymerization. Polymerization was continued for 3 hours at 60° C. 0.5 g samples were withdrawn for % NCO titration to confirm the reaction. The measured NCO value was 6.60% (theoretical % NCO should be 6.65%). This formed the pre-polymer solution.

Then, 7.977 g of 2-(cyclohexylamino)ethanesulfonic acid (CHES) in 20 g of deionized water was added and stirred for 2 hours, followed by the addition of 3.232 g of 50% sodium hydroxide aqueous solution. This reaction formed some of the polyurethane polymer chains 10B in the pre-polymer solution.

Then, 24.008 g of sodium aminoalklysulphonate (A-95, 50% in water) and in 60.019 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 143.836 g of cold deionized water was added to polymer mixture in 4-neck round bottom flask over 10 minutes with good agitation to form the PBP5 dispersion. The agitation was continued for 60 minutes at 40° C. The PBP5 dispersion was filtered through 400 mesh stainless sieve. Acetone was removed with rotorvap at 40° C. (2 drops (20 mg) of BYK-011 de-foaming agent was added). The final PBP5 dispersion was filtered through fiber glass filter paper. The particle size measured by Malvern Zetasizer was 42.17 nm. The pH was 9.5. The solid content was 25.6%.

PBP6 was prepared as follows:

13.927 g of polycarbonate polyol (KURARAY® C-1090, MW 1000), the hydrophobic graft polyol of formula II, wherein o=22, p=2, and q=2 (61.477 g, 72.52% in ethyl acetate), and 26.321 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL were added to initiate the polymerization. Polymerization was continued for 3 hours at 60° C. 0.5 g samples were withdrawn for % NCO titration to confirm the reaction. The measured NCO value was 7.63% (theoretical % NCO should be 7.66%). This formed the pre-polymer solution.

Then, 4.154 g of 2-(cyclohexylamino)ethanesulfonic acid (CHES) in 20 g of deionized water was added and stirred for 2 hours, followed by the addition of 1.683 g of 50% sodium hydroxide aqueous solution. This reaction formed some of the polyurethane polymer chains 10B in the pre-polymer solution.

Then, 25.005 g of sodium aminoalklysulphonate (A-95, 50% in water) and in 62.512 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 141.109 g of cold deionized water was added to polymer mixture in 4-neck round bottom flask over 10 minutes with good agitation to form the PBP6 dispersion. The agitation was continued for 60 minutes at 40° C. The PBP6 dispersion was filtered through 400 mesh stainless sieve. Acetone was removed with rotorvap at 40° C. (2 drops (20 mg) of BYK-011 de-foaming agent was added). The final PBP6 dispersion was filtered through fiber glass filter paper. The particle size measured by Malvern Zetasizer was 11.42 nm. The pH was 9.5. The solid content was 27.6%.

PBP7 was prepared as follows:

13.667 g of polycarbonate polyol (KURARAY® C-1090, MW 1000), the hydrophobic graft polyol of formula II, wherein o=22, p=2, and q=2 (60.327 g, 72.52% in ethyl acetate), and 25.829 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL were added to initiate the polymerization. Polymerization was continued for 3 hours at 60° C. 0.5 g samples were withdrawn for % NCO titration to confirm the reaction. The measured NCO value was 7.65% (theoretical % NCO should be 7.66%). This formed the pre-polymer solution.

Then 4.076 g of 2-(cyclohexylamino)ethanesulfonic acid (CHES) in 20 g of deionized water was added and stirred for 2 hours, followed by the addition of 1.652 g of 50% sodium hydroxide aqueous solution. This reaction formed some of the polyurethane polymer chains 10B in the pre-polymer solution.

Then, 28.278 g of sodium aminoalklysulphonate (A-95, 50% in water) and in 70.694 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 134.907 g of cold deionized water was added to polymer mixture in 4-neck round bottom flask over 10 minutes with good agitation to form the PBP7 dispersion. The agitation was continued for 60 minutes at 40° C. The PBP7 dispersion was filtered through 400 mesh stainless sieve. Acetone was removed with rotorvap at 40° C. (2 drops (20 mg) of BYK-011 de-foaming agent was added). The final PBP7 dispersion was filtered through fiber glass filter paper. The particle size measured by Malvern Zetasizer was 11.58 nm. The pH was 9.5. The solid content was 27.62%.

PBP8 was prepared as follows:

12.999 g of polycarbonate polyol (KURARAY® C-1090, MW 1000), the hydrophobic graft polyol of formula II, wherein o=22, p=2, and q=2 (57.377 g, 72.52% in ethyl acetate), and 24.566 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL was added to initiate the polymerization. Polymerization was continued for 3 hours at 60° C. 0.5 g samples were withdrawn for % NCO titration to confirm the reaction. The measured NCO value was 5.66% (theoretical % NCO should be 5.68%). This formed the pre-polymer solution.

Then, 12.253 g of 3-(cyclohexylamino)-1-propanesulphonic acid (CAPS) in 20 g of deionized water was added and stirred for 2 hours, followed by the addition of 4.650 g of 50% sodium hydroxide aqueous solution. This reaction formed some of the polyurethane polymer chains 10B in the pre-polymer solution.

Then, 19.922 g of sodium aminoalklysulphonate (A-95, 50% in water) and in 49.806 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 152.500 g of cold deionized water was added to polymer mixture in 4-neck round bottom flask over 10 minutes with good agitation to form the PBP8 dispersion. The agitation was continued for 60 minutes at 40° C. The PBP8 dispersion was filtered through 400 mesh stainless sieve. Acetone was removed with rotorvap at 40° C. (2 drops (20 mg) of BYK-011 de-foaming agent was added). The final PBP8 dispersion was filtered through fiber glass filter paper. The particle size measured by Malvern Zetasizer was 86.43 nm. The pH was 9.5. The solid content was 22.87%.

PBP9 was prepared as follows:

13.300 g of polycarbonate polyol (KURARAY® C-1090, MW 1000), the hydrophobic graft polyol of formula II, wherein o=22, p=2, and q=2 (58.708 g, 72.52% in ethyl acetate), and 25.136 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL was added to initiate the polymerization. Polymerization was continued for 3 hours at 60° C. 0.5 g samples were withdrawn for % NCO titration to confirm the reaction. The measured NCO value was 6.63% (theoretical % NCO should be 6.65%). This formed the pre-polymer solution.

Then, 8.471 g of 3-(cyclohexylamino)-1-propanesulphonic acid (CAPS) in 20 g of deionized water was added and stirred for 2 hours, followed by the addition of 3.215 g of 50% sodium hydroxide aqueous solution. This reaction formed some of the polyurethane polymer chains 10B in the pre-polymer solution.

Then, 23.879 g of sodium aminoalklysulphonate (A-95, 50% in water) and in 59.697 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 144.189 g of cold deionized water was added to polymer mixture in 4-neck round bottom flask over 10 minutes with good agitation to form the PBP9 dispersion. The agitation was continued for 60 minutes at 40° C. The PBP9 dispersion was filtered through 400 mesh stainless sieve. Acetone was removed with rotorvap at 40° C. (2 drops (20 mg) of BYK-011 de-foaming agent was added). The final PBP9 dispersion was filtered through fiber glass filter paper. The particle size measured by Malvern Zetasizer was 47.56 nm. The pH was 9.5. The solid content was 25.32%.

PBP10 was prepared as follows:

13.888 g of polycarbonate polyol (KURARAY® C-1090, MW 1000), the hydrophobic graft polyol of formula II, wherein o=22, p=2, and q=2 (61.304 g, 72.52% in ethyl acetate), and 26.247 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL was added to initiate the polymerization. Polymerization was continued for 3 hours at 60° C. 0.5 g samples were withdrawn for % NCO titration to confirm the reaction. The measured NCO value was 7.65% (theoretical % NCO should be 7.66%). This formed the pre-polymer solution.

Then, 4.423 g of 3-(cyclohexylamino)-1-propanesulphonic acid (CAPS) in 20 g of deionized water was added and stirred for 2 hours, followed by the addition of 1.679 g of 50% sodium hydroxide aqueous solution. This reaction formed some of the polyurethane polymer chains 10B in the pre-polymer solution.

Then. 24.935 g of sodium aminoalklysulphonate (A-95, 50% in water) and in 62.337 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, 141.300 g of cold deionized water was added to polymer mixture in 4-neck round bottom flask over 10 minutes with good agitation to form the PBP10 dispersion. The agitation was continued for 60 minutes at 40° C. The PBP10 dispersion was filtered through 400 mesh stainless sieve. Acetone was removed with rotorvap at 40° C. (2 drops (20 mg) of BYK-011 de-foaming agent was added). The final PBP10 dispersion was filtered through fiber glass filter paper. The particle size measured by Malvern Zetasizer was 44.72 nm. The pH was 9.0. The solid content was 26.58%.

PBP11 was prepared as follows:

13.629 g of polycarbonate polyol (KURARAY® C-1090, MW 1000), the hydrophobic graft polyol of formula II, wherein o=22, p=2, and q=2 (60.161 g, 72.52% in ethyl acetate), and 25.758 g of isophorone diisocyanate (IPDI) in 42 g of acetone were mixed in a 500 ml of 4-neck round bottom flask. A mechanical stirrer with glass rod and TEFLON® blade was attached. A condenser was also attached. The flask was immersed in a constant temperature bath at 60° C. The system was kept under a drying tube. 3 drops of DBTDL were added to initiate the polymerization. Polymerization was continued for 3 hours at 60° C. 0.5 g samples were withdrawn for % NCO titration to confirm the reaction. The measured NCO value was 7.65% (theoretical % NCO should be 7.66%). This formed the pre-polymer solution.

Then, 4.340 g of 3-(cyclohexylamino)-1-propanesulphonic acid (CAPS) in 20 g of deionized water was added and stirred for 2 hours, followed by the addition of 1.647 g of 50% sodium hydroxide aqueous solution. This reaction formed some of the polyurethane polymer chains 10B in the pre-polymer solution.

Then, 28.200 g of sodium aminoalklysulphonate (A-95, 50% in water) and in 70.500 g of deionized water were mixed in a beaker until A-95 was completely dissolved. The polymerization temperature was reduced to 40° C. The A-95 solution was added to the pre-polymer solution at 40° C. with vigorous stirring over 5 minutes. The solution became viscous and slight hazy. The mixture was stirred for another 30 minutes at 40° C. This reaction formed some of the polyurethane polymer chains 10A in the solution.

Then, cold 135.112 g of cold deionized water was added to polymer mixture in 4-neck round bottom flask over 10 minutes with good agitation to form the PBP11 dispersion. The agitation was continued for 60 minutes at 40° C. The PBP11 dispersion was filtered through 400 mesh stainless sieve. Acetone was removed with rotorvap at 40° C. (2 drops (20 mg) of BYK-011 de-foaming agent was added). The final PBP11 dispersion was filtered through fiber glass filter paper. The particle size measured by Malvern Zetasizer was 47.3 nm. The pH was 9.5. The solid content was 25.9%.

The black ink formulations are shown in Tables 1A and 1B.

TABLE 1A
Black Inks

| | | Comp. | | | | | |
|---|---|---|---|---|---|---|---|
| | | Ex. 1 | Ex. 2 | Ex. 3 | Ex. 4 | Ex. 5 | Ex. 6 |
| | Specific | (wt % | (wt % | (wt % | (wt % | (wt % | (wt % |
| Ingredient | Component | active) | active) | active) | active) | active) | active) |
| Pigment | Black pigment | 3 | 3 | 3 | 3 | 3 | 3 |
| dispersion | dispersion | | | | | | |
| Binder | CPBP1 | 5 | 0 | 0 | 0 | 0 | 0 |
| | PBP2 | 0 | 5 | 0 | 0 | 0 | 0 |
| | PBP3 | 0 | 0 | 5 | 0 | 0 | 0 |
| | PBP4 | 0 | 0 | 0 | 5 | 0 | 0 |
| | PBP5 | 0 | 0 | 0 | 0 | 5 | 0 |
| | PBP6 | 0 | 0 | 0 | 0 | 0 | 5 |
| Co-solvent | Tripropylene | 5 | 5 | 5 | 5 | 5 | 5 |
| | Glycol | | | | | | |
| Anti-decel | LIPONIC ® EG-1 | 0.5 | 0.5 | 0.5 | 0.5 | 0.5 | 0.5 |
| agent | | | | | | | |
| Anti-kogation | CRODAFOS ™ N- | 0.5 | 0.5 | 0.5 | 0.5 | 0.5 | 0.5 |
| agent | 3A | | | | | | |
| Surfactant | DOWANOL ® | 3 | 3 | 3 | 3 | 3 | 3 |
| | TMP | | | | | | |
| | METOLAT ® 780 | 1.4 | 1.4 | 1.4 | 1.4 | 1.4 | 1.4 |
| Antimicrobial | ACTICIDE ® B20 | 0.03 | 0.03 | 0.03 | 0.03 | 0.03 | 0.03 |
| agent | ACTICIDE ® M20 | 0.013 | 0.013 | 0.013 | 0.013 | 0.013 | 0.013 |
| Wax | Pre-filtered | 0.65 | 0.65 | 0.65 | 0.65 | 0.65 | 0.65 |
| | LIQUILUBE ® LL | | | | | | |
| | 405 | | | | | | |
| Water | Deionized water | Balance | Balance | Balance | Balance | Balance | Balance |

TABLE 1B
Black Inks

| | | Ex. 7 | Ex. 8 | Ex. 9 | Ex. 10 | Ex. 11 |
|---|---|---|---|---|---|---|
| | Specific | (wt % | (wt % | (wt % | (wt % | (wt % |
| Ingredient | Component | active) | active) | active) | active) | active) |
| Pigment | Black pigment | 3 | 3 | 3 | 3 | 3 |
| dispersion | dispersion | | | | | |
| Binder | PBP7 | 5 | 0 | 0 | 0 | 0 |
| | PBP8 | 0 | 5 | 0 | 0 | 0 |
| | PBP9 | 0 | 0 | 5 | 0 | 0 |
| | PBP10 | 0 | 0 | 0 | 5 | 0 |
| | PBP11 | 0 | 0 | 0 | 0 | 5 |
| Co-solvent | Tripropylene | 5 | 5 | 5 | 5 | 5 |
| | Glycol | | | | | |
| Anti-decel | LIPONIC ® EG-1 | 0.5 | 0.5 | 0.5 | 0.5 | 0.5 |
| agent | | | | | | |
| Anti-kogation | CRODAFOS ™ N- | 0.5 | 0.5 | 0.5 | 0.5 | 0.5 |
| agent | 3A | | | | | |
| Surfactant | DOWANOL ® | 3 | 3 | 3 | 3 | 3 |
| | TMP | | | | | |
| | METOLAT ® 780 | 1.4 | 1.4 | 1.4 | 1.4 | 1.4 |
| Antimicrobial | ACTICIDE ® B20 | 0.03 | 0.03 | 0.03 | 0.03 | 0.03 |
| agent | ACTICIDE ® M20 | 0.013 | 0.013 | 0.013 | 0.013 | 0.013 |
| Wax | Pre-filtered | 0.65 | 0.65 | 0.65 | 0.65 | 0.65 |
| | LIQUILUBE ® LL | | | | | |
| | 405 | | | | | |
| Water | Deionized water | Balance | Balance | Balance | Balance | Balance |

A fixer fluid was also used in this example. The formulation of the fixer fluid composition can be found in Table 2, shown below.

TABLE 2
Fixer Fluid Composition

| Ingredient | | Comp. Ex. FF 2 |
|---|---|---|
| Type | Specific Ingredient | Wt % Active |
| Fixing Agent | Calcium Nitrate Tetrahydrate | 11.00 |
| Co-Solvent | Tetraethylene Glycol | 12.00 |
| Surfactant | SURFYNOL ® SEF | 0.045 |
| | (Evonik Ind.) | |
| | SURFYNOL ® CT-211 | 0.020 |
| | (Evonik Ind.) | |
| Chelating Agent | TIRON ™ C | 0.095 |
| Antimicrobial | ACTICIDE ® B20 | 0.04 |
| | (Thor Chemicals) | |
| | ACTICIDE ® M20 | 0.014 |
| | (Thor Chemicals) | |
| Water | Deionized water | Balance |

Example black prints were generated using the fixer fluid and all of the example black inks. Comparative black prints were generated using the fixer fluid and the comparative example black ink. To generate the prints, the fixer fluid was thermal inkjet printed, and then the respective black inks were thermal inkjet printed on different media: Sterling Ultra Gloss #80 (coated glossy media from Verso) (referred to as “SUG”), 80 #Opus Gloss (coated glossy media from Sappi) (referred to as “Opus Gloss”), Somerset Matte 70 #(coated media from Sappi) (referred to as “Somerset Matte”), 50 #White Smooth Offset Plus (uncoated media from Williamsburg) (referred to as “Williamsburg Offset”), and an uncoated media from Pegasus (referred to as “Bulky Shawl”). The loading of the respective ink was about 20 gsm. The prints were then heated at 80° C. for 10 seconds using an IR heating element.

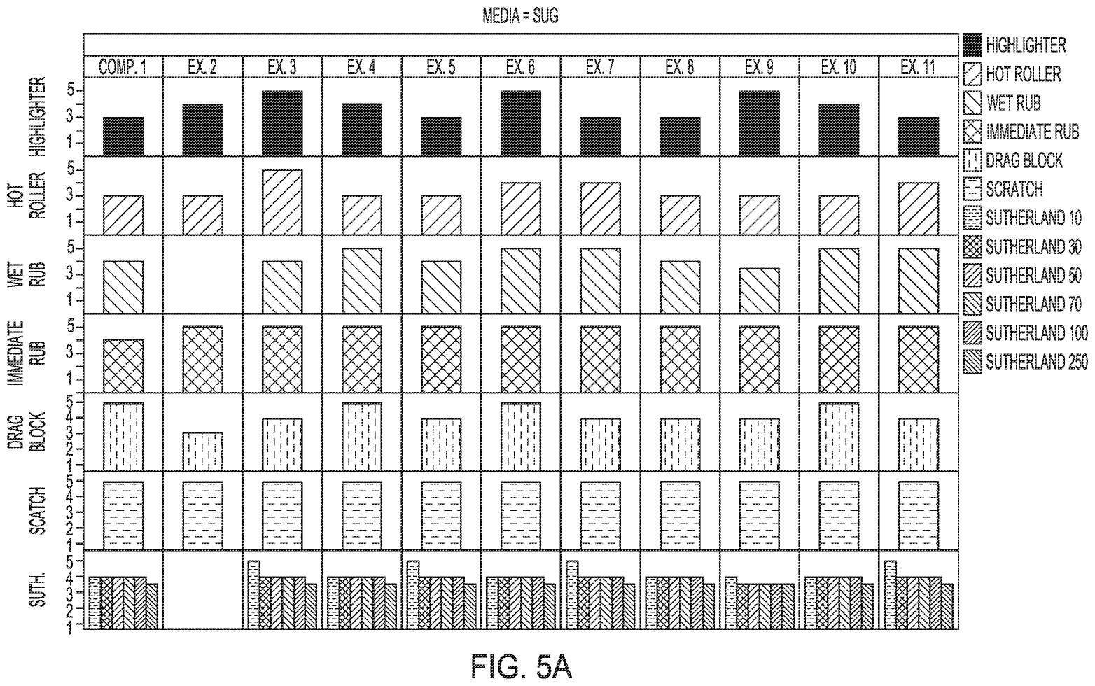

Most of the prints were analyzed for optical density using an X-rite spectrophotometer (available from Color Calibration Group). Prints generated with Ex. 2 and Ex. 8 black inks on any of the media were not evaluated for optical density. Prints generated on Opus Gloss also were not evaluated for optical density. The initial optical density (initial OD) of each other print (after heating) was measured. The optical density results are shown in FIG. 4. Comp. Ex. 1 exhibited good optical density on all of the media, exhibiting an optical density of 0.95 or higher. In comparison to Comp. Ex. 1, all of the example inks (Ex. 3-Ex. 7 and Ex. 9-Ex. 11) exhibited similar performance (1.0+/−0.1) on the uncoated media (Williamsburg Offset and Bulky Shawl). In comparison to Comp. Ex. 1, all of the example inks (Ex. 3-Ex. 7 and Ex. 9-Ex. 11) exhibited slightly more varied performance on the coated media (SUG and Somerset Matte). On SUG, the example inks were within 0.15 of the print generated with Comp. Ex. 1, and on Somerset Matte, the example inks were within 0.16 of the print generated with Comp. Ex. 1. Ex. 11 black ink outperformed the Comp. Ex. 1 black ink, in terms of optical density, on all of the coated and uncoated media. Overall, the example inks exhibited relatively consistent optical density performance across the coated and uncoated media.

Most of the prints were also analyzed for durability using several different tests. Each test was performed on a dedicated black patch of each print. Prints generated on Somerset Matte and Bulky Shawl were not evaluated for durability. The print durability was assessed by the print patch's ability to retain color after being exposed to a respective ink removal test. More specifically, each patch was visually inspected for ink defects, such as ink removal, and graded according to the scale described in Table 2 (below). These removal tests included highlighter, hot-roller, wet-rub, immediate rub, drag block, scratch and Sutherland tests.

The highlighter test involved dragging a highlighter once across a dedicated patch of the print immediately after printing and heating.

The hot-roller test involved rubbing a 50° C. heating roller once across a dedicated patch of the print immediately after printing and heating.

The wet-rub test was carried out on a dedicated black patch of each print using an abrasion scrub tester as follows. The dedicated black patches were exposed to 3-6 drops. An 800 g weight was loaded on the test header that moves back and forth. The test tip was made of acrylic resin with crock cloth. The test cycle speed was then set to 25 cm/min and 5 cycles were carried out on each wetted patch at an 8 inch length for each cycle. The test probe was in wet (wet rub) mode.

The immediate rub test involved A SUTHERLAND® 2000 rub tester being used once across a dedicated patch of the print immediately after printing. The prints were mounted face down on the rub tester, and a weight of 1814.37 g (or 4 lbs) was placed over the backside of the media. The tester was operated once, where the weight was rubbed once across the backside of the media opposed to where the print patches were formed.

The drag block test involved dragging a 10 g block across a dedicated patch of the print one time after printing and heating.

The scratch test was performed by exposing a dedicated patch of the print to a coin at a 45° angle under a normal force of 250 g, which was then dragged across the patch. The test was performed with a BYK Abrasion Tester (from BYK-Gardner USA, Columbus, Md.) with a linear, back-and-forth motion of the angled coin, attempting to scratch off the black patch, for 5 cycles.

A SUTHERLAND® 2000 rub tester was used to perform several dry rub tests. Again, dedicated patches of the print were tested. The prints were mounted face down on the rub tester, and a weight of 1814.37 g (or 4 lbs) was placed over the backside of the media. The tester was operated for between 100 and 250 strokes, where the weights were rubbed back and forth across the backside of the media opposed to where the print patches were formed.

As noted above, all of the tested patches were visually inspected for ink defects, such as ink removal, and graded according to the scale described in Table 3.

TABLE 3
Graded Scale for Visual Defects of Durability Tests

| Score | Description |
|---|---|
| 1 | Severe defects in print |
| 2 | Many defects easily seen at 1M distance |
| 3 | Acceptable level of defects |
| 4 | Slight defects at 1M distance |
| 5 | No defects observed |

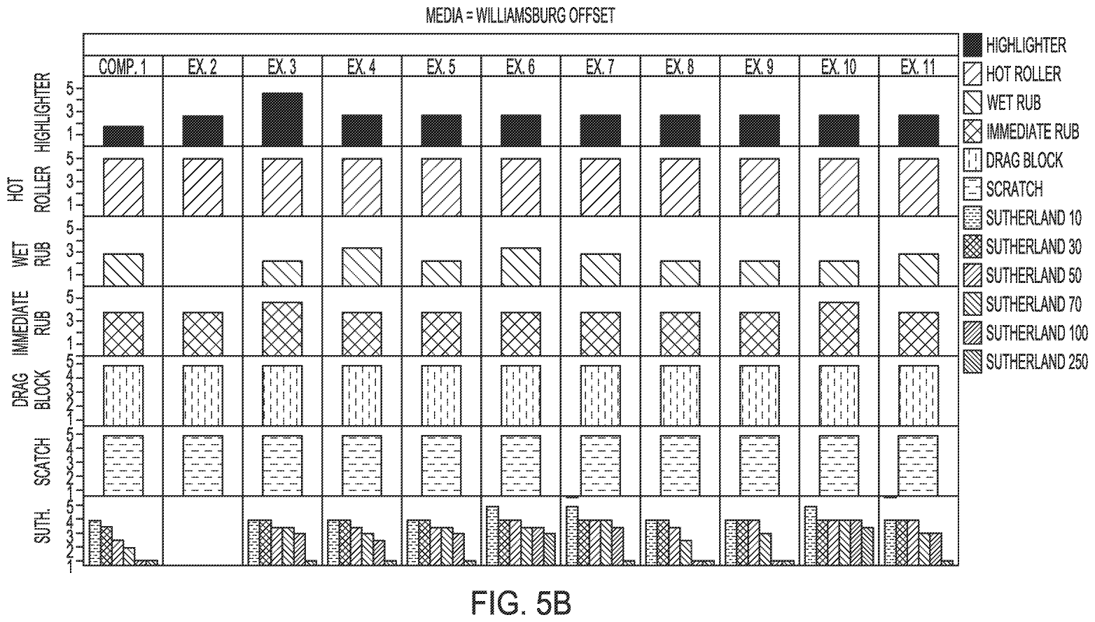

FIG. 5A depicts the durability results for the prints generated on SUG (coated), FIG. 5B depicts the durability results for the prints generated on Williamsburg Offset (uncoated), and FIG. 5C depicts the durability results for the prints generated on Opus Gloss (coated). Data was not collected for some of the prints, and these sections of the graphs depict no data.

As shown in FIG. 5A, all of the prints generated with the example black inks (Ex. 2 through Ex. 11) exhibited good/acceptable (score of 3) or excellent (scores of 4 or 5) durability on SUG, and generally performed as good as or better than the prints generated with the comparative example black ink (Comp. Ex. 1) in all of the durability tests except the drag block test.

As shown in FIG. 5B, all of the prints generated with the example black inks (Ex. 2 through Ex. 11) exhibited good (score of 3) or excellent (scores of 4 or 5) durability on Williamsburg Offset in the highlighter, hot roller, immediate rub, drag block, and scratch tests. In each of these tests, the example black inks (Ex. 2 through Ex. 11) generally performed as good as or better than the prints generated with the comparative example black ink (Comp. Ex. 1). The example black inks (Ex. 3, Ex. 5, and Ex. 8 through Ex. 10) did not perform as well in the wet rub durability test on the Williamsburg Offset media. The example black inks (Ex. 2 through Ex. 11) generally performed as good as or better than the prints generated with the comparative example black ink (Comp. Ex. 1) in the Sutherland tests as well.

As shown in FIG. 5C, all of the prints generated with the example black inks (Ex. 2 through Ex. 11) exhibited good/acceptable (score of 3) or excellent (scores of 4 or 5) durability on Opus Gloss, and generally performed as good as or better than the prints generated with the comparative example black ink (Comp. Ex. 1) in all of the durability tests except the wet rub test and the drag block test. From the results in FIG. 5A through FIG. 5C, it can be seen that the overall durability of the prints generated with the example black inks was improved when compared to the prints generated with the comparative example black ink.

The example and comparative black inks were also tested for stability and/jettability.

Samples of each of the example black inks (Ex. 2 through Ex. 11) and the comparative example black ink (Comp. Ex. 1) were tested for stability. The particle size was measured at ambient temperature after the inks were prepared, and then samples were exposed to accelerated shelf life testing or T-cycle testing.

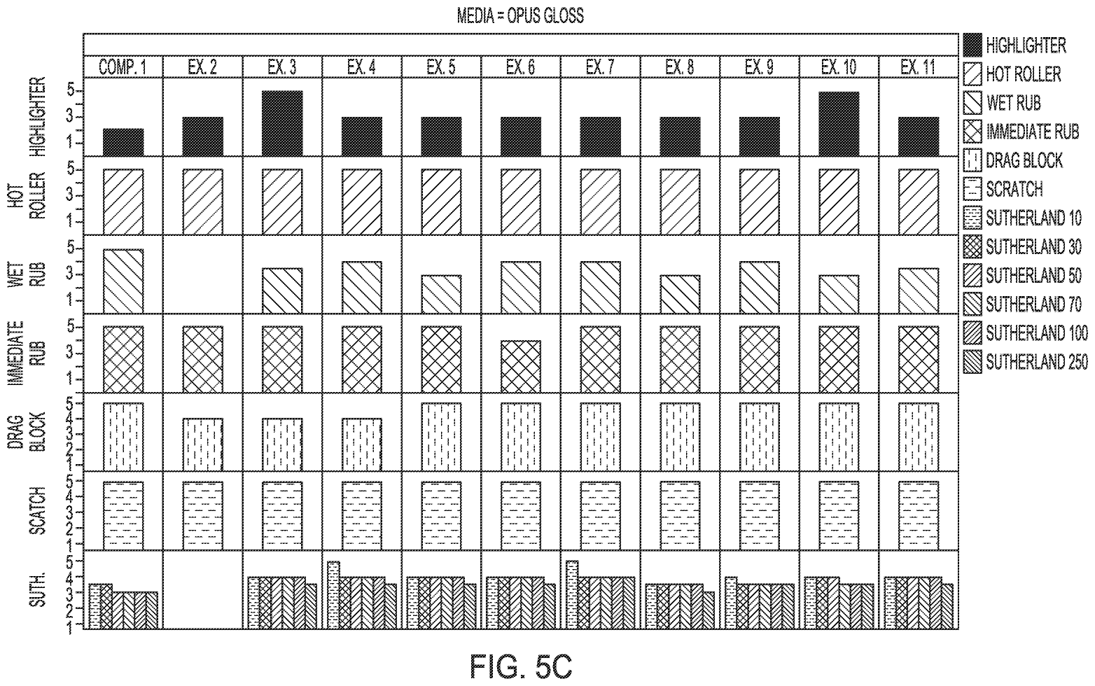

The particle size for each example and comparative example black ink sample was measured in terms of the volume-weighted mean diameter (Mv) using dynamic light scattering with the NANOTRAC® WAVE™ particle size analyzer. The particle size measurements taken at ambient temperature are shown in FIG. 6 (PS MV AMB). It is noted that FIG. 6 illustrates the type and amount of mono-amino substituted sulfonic acid in each of the example inks as well as the carboxylated diol used in the comparative example ink.

Samples of the example and comparative example black inks were then stored in an accelerated storage (AS) or accelerated shelf life (ASL) environment at a temperature of 60° C. for one week. The particle size for each example and comparative example black inks was measured after the ink samples were stored in the AS environment. The particle size was measured in terms of the volume-weighted mean diameter (Mv) using dynamic light scattering with the NANOTRAC® WAVE™ particle size analyzer. The particle size (volume-weighted mean diameter) for each example and comparative example black ink after ASL is shown in FIG. 6.

Additionally, samples of each example and comparative example black ink was put through a T-cycle test. During the T-cycle, each example and comparative example black ink was heated to and maintained at a high temperature of 70° C. for 4 hours, and then each ink was cooled to and maintained at a low temperature of −40° C. for 4 hours. This process was repeated for each example and comparative example black ink sample for 5 cycles. For each example and comparative example black ink sample, the particle size was measured in terms of the volume-weighted mean diameter (Mv) after the T-cycle test. The particle size (volume-weighted mean diameter) for each example and comparative example black ink after the T-cycle test is shown in FIG. 6.

The results in FIG. 6 indicate that example black inks Ex. 3, Ex. 4, Ex. 6, Ex. 7, Ex. 10, and Ex. 11 performed as good as the comparative black inks in terms of stability. The stability of example black inks Ex. 2, Ex. 5, Ex. 8, and Ex. 9 was not as good, which may be attributed to the larger particle size of the polyurethane binder particles in each of these inks.

The jettability performance of some of the example black inks (Ex. 3 through Ex. 11) and of the comparative example black ink (Comp. Ink 1) was tested. The black inks were printed using a thermal inkjet printer. The jettability performance was evaluated for drop weight, drop velocity, decel performance, and decap performance.

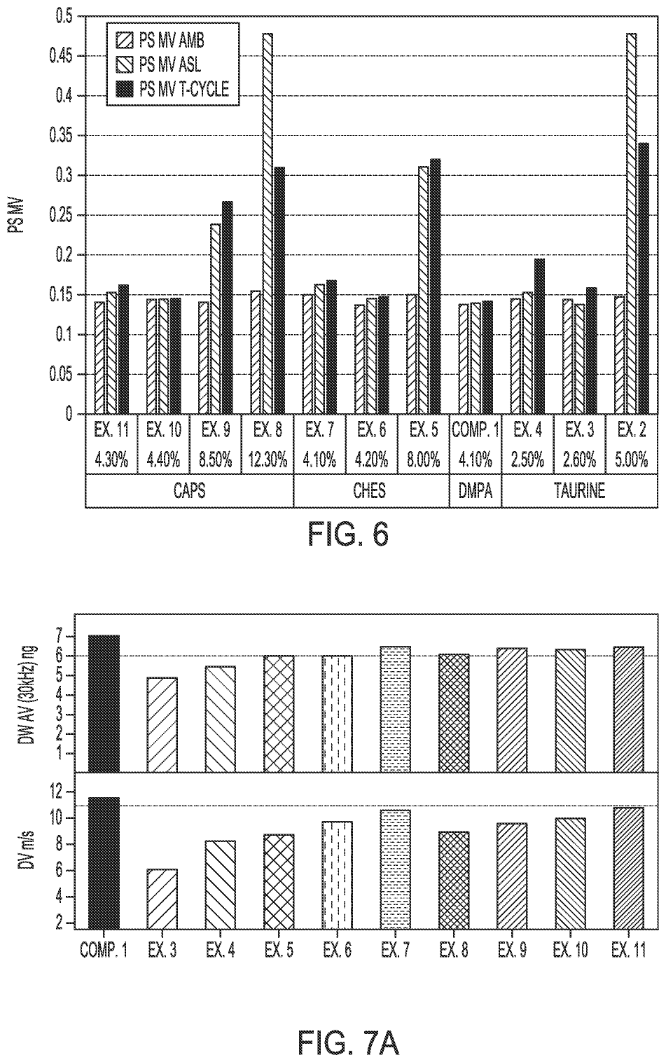

Both the drop weight (in terms of ng) and the drop velocity (in terms of m/s) of the black inks were monitored. The average drop weight of 2,000 drops fired at a firing frequency of 30 KHz was calculated. The results for drop weight (top graph in FIG. 7A) and drop velocity (bottom graph in FIG. 7A) of each black ink that was tested are shown in FIG. 7A.

The example black inks (Ex. 3 through Ex. 11) exhibited good jettability, as shown with drop weights around 6 ng and drop velocity around 11 m/s. While the comparative black ink (Comp. Ex. 1) had a slightly higher drop weight (about 7 ng) and slightly higher drop velocity (about 12 m/s), the inks performed comparably.

The term “decel,” as referred to herein, refers to a decrease in the drop velocity over time (e.g., 6 seconds) of droplets fired from an inkjet printhead. A large decrease in drop velocity (e.g., a decrease in drop velocity of greater than 0.5 m/s) can lead to poor image quality, which can be observed, for example, by the color difference between the print samples from continuously firing nozzles and the print samples from non-continuously firing nozzles. In contrast, fluids that do not experience decel (i.e., no decrease in drop velocity) or experience an acceptable decel (e.g., a decrease in drop velocity of 0.5 m/s or less) will continue to generate quality printed images. In order to determine decel performance, each of the example and comparative example magenta inks was filled into a thermal inkjet print head and the drop velocity vs. firing time over 6 seconds was collected. The results of the decel performance test for some of the example black inks (Ex. 3-Ex. 11) and the comparative example black ink (Comp. Ex. 1) are shown in FIG. 7B.

The example black inks Ex. 3 and Ex. 4 exhibited an undesirable decel with the decrease being well over 0.5 m/s. The remainder of the example inks, Ex. 5 through Ex. 11 had acceptable decel performances, with the decrease being close to or less than 0.5 m/s.

The term “decap performance,” as referred to herein, means the ability of the ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. To test the decap performance, a reference line of the ink was printed from a printhead that was not uncapped (i.e., was not exposed to air). Then, the printhead was filled with the ink and left uncapped (i.e., exposed to air) for a predetermined amount of time (e.g., 7 seconds) before the ink was ejected again from the printhead. A score was then assigned to the ink based on the number of spits performed before a line with the same print quality as the reference line was printed. A lower decap score indicates higher quality firing of the nozzles and less clogging, plugging, or retraction of the colorant from the drop forming region of the nozzle/firing chamber. A decap score higher than 15 (>15) indicates that a good line was not obtained after 15 spits. The results of the decap performance test for some of the example black inks (Ex. 3-Ex. 11) and the comparative example black ink (Comp. Ex. 1) are also shown in FIG. 7B.

The example black inks, Ex. 3-Ex. 11 and the comparative black ink, Comp. Ex. 1, exhibited acceptable decap performance scores of 5 or less (well below 15).

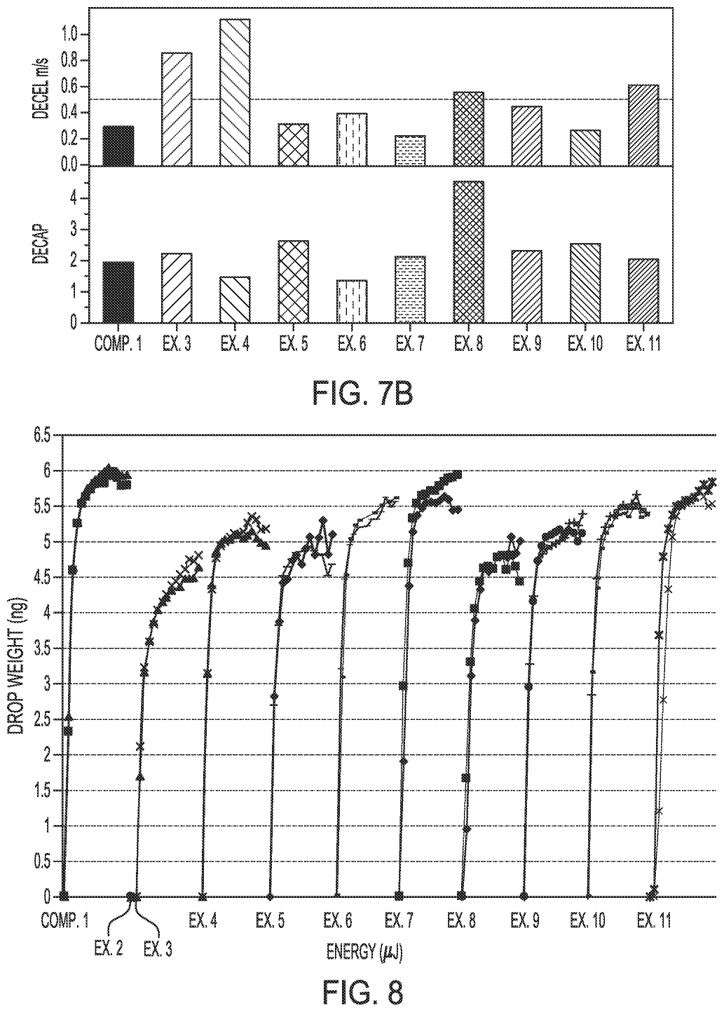

All of the black inks were also tested for Turn-On-Energy. The term “Turn-On Energy (TOE) curve,” as used herein, refers to the drop weight of the ink as a function of firing energy. An inkjet fluid with good jettability performance also has a good TOE curve, where the fluid drop weight rapidly increases (with increased firing energy) to reach a designed drop weight for the pen architecture used; and then a steady drop weight is maintained when the firing energy exceeds the TOE. In other words, a sharp TOE curve may be correlated with good jettability performance. In contrast, an inkjet fluid with a poor TOE curve may show a slow increase in drop weight (with increased firing energy) and/or may never reach the designed drop weight for the pen architecture. A poor TOE curve may be correlated with poor jettability performance. The TOE curves for the example black inks, Ex. 2 through Ex. 11, and the comparative black ink, Comp. Ex. 1, are shown in FIG. 8 (plotting drop weight in nanograms (ng) vs. firing energy in microJoules (μJ)). As depicted in FIG. 8, each of the example black inks Ex. 4-Ex. 11 and the comparative black ink Comp. Ex. 1 exhibited a good TOE curve, indicating good jettability via thermal inkjet printheads. The example black inks Ex. 2 and Ex. 3 had slightly lower, yet still acceptable, TOE curves.

It is to be understood that the ranges provided herein include the stated range and any value or sub-range within the stated range, as if the value(s) or sub-range(s) within the stated range were explicitly recited. For example, a range from about 0.5 wt % active to about 15 wt % active, should be interpreted to include not only the explicitly recited limits of from about 0.5 wt % active to about 15 wt % active, but also to include individual values, such as about 4.15 wt % active, about 12.5 wt % active, 6.23 wt % active, 14.0 wt % active, etc., and sub-ranges, such as from about 5 wt % active to about 15 wt % active, from about 3 wt % active to about 7 wt % active, from about 0.75 wt % active to about 12.5 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink, comprising:
a polyurethane binder particle including at least two polyurethane polymers, wherein:
a first of the at least two polyurethane polymers has a first backbone chain formed from a first diisocyanate, a first hydrophobic graft diol, a first polycarbonate based diol, and a sulfonated diamine; and
a second of the at least two polyurethane polymer has a second backbone chain formed from a second diisocyanate, a second hydrophobic graft diol, and a second polycarbonate based diol, and includes a mono-amino substituted sulfonic acid as its capping moiety;
a pigment; and
an aqueous vehicle.

2. The inkjet ink as defined in claim 1, wherein the mono-amino substituted sulfonic acid is selected from the group consisting of 2-aminoethanesulfonic acid, N-cyclohexyl-2-aminoethanesulfonic acid, and N-cyclohexyl-3-aminopropanesulfonic acid.

3. The inkjet ink as defined in claim 1, wherein the polyurethane binder particle has an acid number of less than 61 and a particle size ranging from about 10 nm to about 100 nm.

4. The inkjet ink as defined in claim 1, wherein the polyurethane binder particle has a weight average molecular weight ranging from about 5,000 g/mol to about 50,000 g/mol.

5. The inkjet ink as defined in claim 1, wherein each of the first and second hydrophobic grafted diols has formula (I): 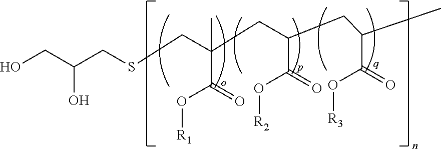
wherein:
R₁ is methyl, ethyl, propyl, butyl, pentyl, or hexyl;
R₂ is a branched alkyl group selected from the group consisting iso-propyl, 2-methylbutyl, 2-methylpentyl, 2-methylhexyl, 2-ethylbutyl, 2-ethylpentyl, 2-ethylhexyl, 2-propylbutyl, 2-propylpentyl, and 2-propylhexyl;
R₃ is (OCH₂CH₂)₂OCH₂CH₃; (OCH₂CH₂)₃OCH₂CH₃; (OCH₂CH₂)₄OCH₂CH₃; (OCH₂CH₂)₅OCH₂CH₃; (OCH₂(OCH₂CH₂)₆)OCH₂CH₃; (OCH₂CH₂)₇OCH₂CH₃; (OCH₂CH₂)₂OCH₃; (OCH₂CH₂)₃OCH₃; (OCH₂CH₂)₄OCH₃; (OCH₂CH₂)₅OCH₃; (OCH₂(OCH₂CH₂)₆)OCH₃; or (OCH₂CH₂)₇OCH₃;
o ranges from 1 to 50;
p ranges from 1 to 50;
q ranges from 1 to 50; and
n ranges from 1 to 30.

6. The inkjet ink as defined in claim 5, wherein a weight average molecular weight of each of the first and second hydrophobic grafted diols ranges from about 1,000 g/mol to about 15,000 g/mol.

7. The inkjet ink as defined in claim 1, wherein the polyurethane binder particle is present in an amount ranging from about 0.1 wt % active to about 20 wt % active based on a total weight of the inkjet ink.

8. The inkjet ink as defined in claim 1, wherein the pigment is present in an amount ranging from about 0.5 wt % active to about 15 wt % active based on a total weight of the inkjet ink.

9. The inkjet ink as defined in claim 1, wherein the aqueous vehicle consists of water, or water, a co-solvent and an additive selected from the group consisting of a surfactant, an anti-kogation agent, an anti-decel agent, an antimicrobial agent, a viscosity modifier, a pH adjuster, a chelating agent, a wax, and combinations thereof.

10. The inkjet ink as defined in claim 1, wherein the aqueous vehicle is present in an amount of at least 30 wt % based on a total weight of the inkjet ink.

11. A method for making an inkjet ink, comprising:
introducing a polyurethane dispersion into an aqueous vehicle, the polyurethane dispersion including:
a polyurethane binder particle including at least two polyurethane polymers, wherein:
a first of the at least two polyurethane polymers has a first backbone chain formed from a first diisocyanate, a first hydrophobic graft diol, a first polycarbonate based diol, and a sulfonated diamine; and
a second of the at least two polyurethane polymer has a second backbone chain formed from a second diisocyanate, a second hydrophobic graft diol, and a second polycarbonate based diol, and includes a mono-amino substituted sulfonic acid as its capping moiety; and
water; and
incorporating a pigment into the aqueous vehicle.

12. The method as defined in claim 11, wherein:
the first and second diisocyanates are a same type of diisocyanate, the first and second hydrophobic graft diols are a same type of hydrophibic graft diol, and the first and second polycarbonate based diol are a same type of polycarbonate based diol; and
the method further comprises making the polyurethane binder particle by:
reacting the same type of diisocyanate, the same type hydrophobic graft diol, the same type polycarbonate based diol to form a plurality of pre-polymer chains;
reacting the mono-amino substituted sulfonic acid with some of the pre-polymer chains to form the second of the at least two polyurethane polymers; and
reacting the sulfonated diamine with other of the pre-polymer chains to form the first of the at least two polyurethane polymers.

13. The method as defined in claim 11, wherein each of the first and second hydrophobic grafted diols has formula (I): 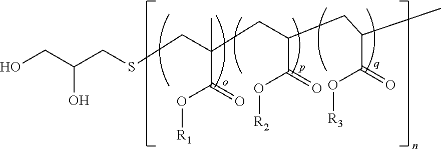
wherein:
R₁ is methyl, ethyl, propyl, butyl, pentyl, or hexyl;
R₂ is a branched alkyl group selected from the group consisting iso-propyl, 2-methylbutyl, 2-methylpentyl, 2-methylhexyl, 2-ethylbutyl, 2-ethylpentyl, 2-ethylhexyl, 2-propylbutyl, 2-propylpentyl, and 2-propylhexyl;
R₃ is (OCH₂CH₂)₂OCH₂CH₃; (OCH₂CH₂)₃OCH₂CH₃; (OCH₂CH₂)₄OCH₂CH₃; (OCH₂CH₂)₅OCH₂CH₃; (OCH₂(OCH₂CH₂)₆)OCH₂CH₃; (OCH₂CH₂)₇OCH₂CH₃; (OCH₂CH₂)₂OCH₃; (OCH₂CH₂)₃OCH₃; (OCH₂CH₂)₄OCH₃; (OCH₂CH₂)₅OCH₃; (OCH₂(OCH₂CH₂)₆)OCH₃; or (OCH₂CH₂)₇OCH₃;
o ranges from 1 to 50;
p ranges from 1 to 50;
q ranges from 1 to 50; and
n ranges from 1 to 30.

14. A printing method, comprising:
digitally printing an inkjet ink on a substrate to form a printed image, the inkjet ink including:
a polyurethane binder particle including at least two polyurethane polymers, wherein:
a first of the at least two polyurethane polymers has a first backbone chain formed from a first diisocyanate, a first hydrophobic graft diol, a first polycarbonate based diol, and a sulfonated diamine; and
a second of the at least two polyurethane polymer has a second backbone chain formed from a second diisocyanate, a second hydrophobic graft diol, and a second polycarbonate based diol, and includes a mono-amino substituted sulfonic acid as its capping moiety; and
exposing the substrate having the printed image thereon to a temperature ranging from about 50° C. to about 120° C.

15. The printing method as defined in claim 14, wherein the digital printing of the inkjet ink is performed with a thermal inkjet printer.

16. The printing method as defined in claim 14, further comprising applying a fixer fluid to the substrate before the inkjet ink.
